(19) United States
(12) Patent Application Publication
(10) Pub. No.: US 2022/0414919 A1
(43) Pub. Date: Dec. 29, 2022

(54) METHOD AND APPARATUS FOR DEPTH-AIDED VISUAL INERTIAL ODOMETRY

(71) Applicant: Samsung Electronics Co., Ltd., Gyeonggi-do (KR)

(72) Inventors: Abhishek TYAGI, San Diego, CA (US); Yangwen Liang, San Diego, CA (US); Shuangquan Wang, San Diego, CA (US); Dongwoon Bai, San Diego, CA (US); Vignesh Sethuraman, San Diego, CA (US); Xue Li, San Diego, CA (US)

(21) Appl. No.: 17/726,124

(22) Filed: Apr. 21, 2022

Related U.S. Application Data
(60) Provisional application No. 63/192,488, filed on May 24, 2021.

(51) Int. Cl. G06T 7/73; G01C 21/16; G06T 7/579

(52) U.S. Cl. CPC G06T 7/73; G01C 21/165; G06T 7/579

(57) ABSTRACT

A method and an apparatus are provided for performing visual inertial odometry (VIO). Measurements are processed from an inertial measurement unit (IMU), a camera, and a depth sensor. Keyframe residue including at least depth residue is determined based on the processed measurements. A sliding window graph is generated and optimized based on factors derived from the keyframe residue. An object pose is estimated based on the optimized sliding window graph.

### PRIORITY

This application is based on and claims priority under 35 U.S.C. § 119(e) to a U.S. Provisional Patent Application filed on May 24, 2021, in the United States Patent and Trademark Office, and assigned Ser. No. 63/192,488, the contents of which are incorporated herein by reference.

### FIELD

The present disclosure relates generally to a visual inertial odometry system, and more particularly, to a visual inertial odometry (VIO) system incorporating depth measurements to vision and inertial measurement.

### BACKGROUND

In modern smartphones, there has been an increase in the number of sensors that can be used for localization in an augmented reality (AR) or a three-dimensional reconstruction (3DR) application. Types of simultaneous localization and mapping (SLAM) systems include vision-only SLAM systems and inertial measurement unit (IMU)-aided vision SLAM systems, which are referred to as VIO systems. Vision-only SLAM systems that use both camera and depth sensors for estimating camera trajectory include oriented fast and rotated brief (ORB) SLAM version 2 (SLAM2) and red-green-blue depth (RGBD) SLAM. These two systems use depth measurements to improve pose estimation performed by the two-dimensional (2D) feature-based vision-only SLAM system.

VIO systems are used in tracking six degrees of freedom (6DOF) for an object pose using data from a camera image (e.g., vision data) and an IMU. VIO systems use unique features, which are tracked in camera images, accelerometer data, and gyroscope data, as measurements to estimate the object pose through a tightly coupled system that uses mathematical optimization techniques.

### SUMMARY

According to one embodiment, a method is provided for performing VIO at a user equipment (UE). Measurements are processed from an IMU, a camera, and a depth sensor of the UE. Keyframe residue including at least depth residue is determined based on the processed measurements. A sliding window graph is generated and optimized based on factors derived from the keyframe residue. An object pose of the UE is estimated based on the optimized sliding window graph.

According to one embodiment, a UE is provided that includes an IMU, a camera, a depth sensor, a processor, and a non-transitory computer readable storage medium that stores instructions. When executed the instructions cause the processor to process measurements from the IMU, the camera, and the depth sensor. The instructions also cause the processor to determine keyframe residue including at least a depth residue based on the processed measurements, and generate and optimize a sliding window graph based on factors derived from the keyframe residue. The instructions further cause the processor to estimate an object pose of the UE based on the optimized sliding window graph.

### BRIEF DESCRIPTION OF THE DRAWINGS

The above and other aspects, features, and advantages of certain embodiments of the present disclosure will be more apparent from the following detailed description, when taken in conjunction with the accompanying drawings, in which:

FIG. 1 is a diagram illustrating a factor graph of a monocular visual inertial navigation system (VINS-Mono);

FIG. 2 is a diagram illustrating a factor graph for MSL-depth-aided VIO (DVIO), according to an embodiment;

FIG. 3 is a diagram illustrating a time of flight (TOF) camera, according to an embodiment, according to an embodiment;

FIG. 4 is a diagram illustrating structured light sensors, according to an embodiment;

FIG. 5 is a diagram illustrating a system flow of the MSL-DVIO, according to an embodiment;

FIG. 6 is a diagram illustrating a detailed system flow of the MSL-DVIO, according to an embodiment of the disclosure;

FIG. 7 is a diagram illustrating MSL-DVIO 1D feature implementation, according to an embodiment;

FIG. 8 is a diagram illustrating details on the implementation of the MSL-DVIO for 3D feature parameterization, according to an embodiment;

FIG. 9 is a flowchart illustrating a method for performing VIO at a UE, according to an embodiment; and

FIG. 10 is a block diagram of an electronic device in a network environment, according to an embodiment.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate the existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The electronic device may be one of various types of electronic devices. The electronic devices may include, for example, a portable communication device (e.g., a smart phone), a computer, a portable multimedia device, a portable medical device, a camera, a wearable device, or a home appliance. According to one embodiment of the disclosure, an electronic device is not limited to those described above.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2nd,” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, or firmware, and may interchangeably be used with other terms, such as, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC).

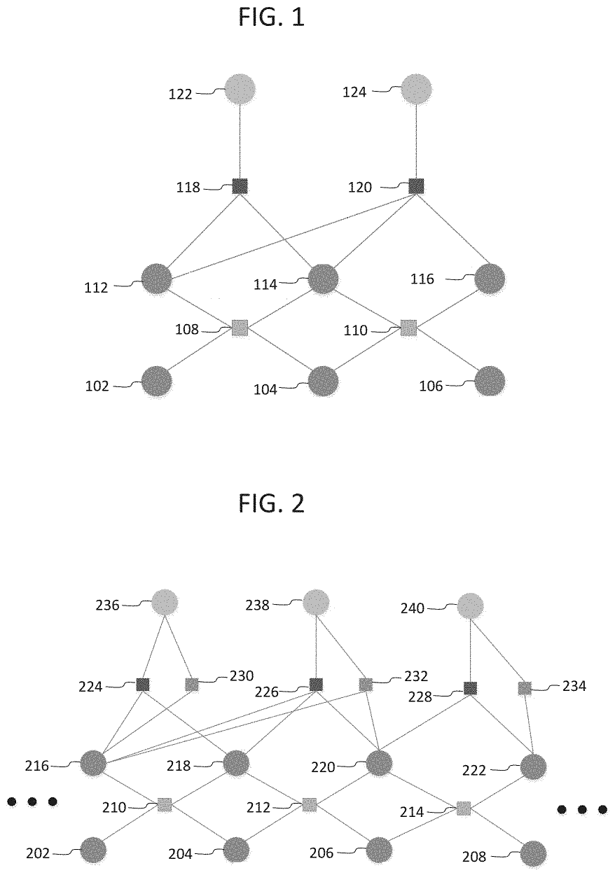

FIG. 1 is a diagram illustrating a factor graph of a VINS-Mono. xₖ denotes a full state of robot motion. State variables can be written as Equation (1) below, as defined by Table 1.

$${x}_{k}^{n a v} = [ \begin{matrix}{x}_{k}^{R} \\ {x}_{k}^{S B}\end{matrix} ] = [ \begin{matrix}{p}_{k}^{w} \\ {q}_{k}^{w} \\ {ν}_{k}^{w} \\ {b}_{{a}_{k}} \\ {b}_{{ω}_{k}}\end{matrix} ] \qquad ( 1 )$$

The robot pose state is defined as

$${x}_{k}^{R} := [ \begin{matrix}{p}_{k}^{w} \\ {q}_{k}^{w}\end{matrix} ]$$

and the robot speed and bias state is defined as

$${x}_{k}^{S B} := [ \begin{matrix}{ν}_{k}^{w} \\ {b}_{{a}_{k}} \\ {b}_{{ω}_{k}}\end{matrix} ] .$$

TABLE 1

| State | | |
|---|---|---|
| variable | Size | Descriptions |
| xₖ^{nav} | 16 × 1 | Full robot state at frame k |
| xₖ^{R} | 7 × 1 | Robot pose state |
| xₖ^{SB} | 9 × 1 | Robot speed and bias state |
| pₖ^{w} | 3 × 1 | Position (in world frame) |
| qₖ^{w} | 4 × 1 | Orientation quaternion (in world frame) |
| vₖ^{w} | 3 × 1 | Speed (in world frame) |
| bₐ_{ₖ} | 3 × 1 | Bias estimation of accelerometer |
| b_{ω}_{ₖ} | 3 × 1 | Bias estimation of gyroscope |

For the entire VINS-Mono of FIG. 1, a sliding window-based tightly-coupled VIO for state estimation includes n+1 robot states x^{nav} and m+1 3D landmark inverse depths

$${λ}_{i} = \frac{1}{{d}_{i}} , i ∈ \{ 0 , … , m \} .$$

The state vector within the sliding window is defined as set forth in Equation (2) below.

X=[x^{nav}; x^{feat}] (2)

where x^{nav}=[x₀^{nav}; x₁^{nav}; . . . ; xₙ^{nav}] with

$${x}_{k}^{n a v} = [ \begin{matrix}{x}_{k}^{R} \\ {x}_{k}^{S B}\end{matrix} ] ,$$

pose, speed, and bias for k^{th} keyframes, and x^{feat}=[λ₀ . . . λₘ], landmark inverse depth as observed in the first camera keyframe. This first keyframe to which the landmark measurement is anchored is referred to as an anchor frame.

In VINS-Mono, a solution is sought for Equation (3) below.

$${min}_{X} \{ {‖ {r}_{M} ( {X}_{r} ) ‖}^{2} + {\sum }_{k ∈ {B}_{w}} {‖ {r}_{IMU} ( {x}_{k} , {x}_{k + 1} ) ‖}_{{P}_{{b}_{k + 1}}^{{b}_{k}}}^{2} + {\sum }_{( i , j , l ) ∈ {ℱ}_{w}} {‖ {r}_{VIS} ( {x}_{i}^{R} , {x}_{j}^{R} , {λ}_{l} ) ‖}_{Q}^{2} \} \qquad ( 3 )$$

Here, B_{w} is an index of the sliding window, [symbol] is a set of observations within the sliding window, X=∪_{k∈B}_{_{w}} {xₖ} is a set of state variables to optimize over, r_{IMU}(xₖ,xₖ₊₁) is an IMU factor, r_{VIS}(xᵢ^{R},xⱼ^{R},λₗ) is a vision factor, r_{M}(Xᵣ) is a marginalization factor, Xᵣ is a full state after marginalization,

$${P}_{{b}_{k + 1}}^{{b}_{k}}$$

is a covariance matrix for the IMU part to generate the

Mahalanobis distance for the residue, and Q is a covariance matrix for the vision part needed to generate the Mahalanobis distance for the residue.

Thus, FIG. 1 illustrates a relationship between the factors x₁^{SB} 102, x₂^{SB} 104, x₃^{SB} 106, r_{IMU}(x₁, x₂) 108, r_{IMU}(x₂, x₃) 110, x₁^{R} 112, x₂^{R} 114, x₃^{R} 116, r_{VIS}(x₁^{R},x₂^{R},λⱼ118, r_{VIS}(x₁^{R},x₂^{R},λᵢ) and r_{VIS}(x₁^{R},x₃^{R},λᵢ) 120, λⱼ 122, and λᵢ 124.

Since embodiments in MSL-DVIO impact the vision factor in the above-described factor graph approach, the vision factor is described in detail below. The IMU factor is described in detail further below.

In MSL-DVIO, which is an RGBD+IMU system, the vision factor is generated from the feature measurement of the camera image and the depth map. The IMU factor for MSL-DVIO is the same as that for VINS-Mono. Unlike the VINS-Mono, the depth map is available along with the camera capture for MSL-DVIO.

FIG. 2 is a diagram illustrating a factor graph for MSL-DVIO, according to an embodiment. Specifically, FIG. 2 illustrates a relationship between the factors x₁^{SB} 202, x₂^{SB} 204, x₃^{SB} 206, x₄^{SB} 208, r_{IMU}(x₁, x₂) 210, r_{IMU}(x₂, x₃) 212, r_{IMU}(x₃, x₄) 214, x₁^{R} 216, x₂^{R} 218, x₃^{R} 220, x₄^{R} 222, r_{VIS}(x₁^{R},x₂^{R},λⱼ) 224, r_{VIS}(x₁^{R},x₂^{R},λᵢ) and r_{VIS}(x₁^{R},x₃^{R},λᵢ) 226, r_{VIS}(x₃^{R},x₄^{R},λₘ) 228, r_{DP}(x₁^{R},λᵢ) 230, r_{DP}(x₁^{R},x₃^{R},λⱼ) 232, r_{DP}(x₄^{R},λₘ) 234, λⱼ 236, λᵢ 238, and λₘ 240. r_{DP} is a depth residual.

The terms “residue” and “residual” may be used interchangeably, and generally define a computing loss between an estimated value of state parameters and a measured value from a sensor.

The image feature detection and tracker from VINS-Mono are adopted in MSL-DVIO. For each detected feature, a corresponding depth is extracted from the depth map and a depth residual factor is formed. Due to the nature of the depth map, occlusions and out-of-range may occur and the corresponding depth for the feature point may not be always available. Therefore, the number of depth factors is less than or equal to the number of image feature factors, as shown in FIG. 2.

For an RGBD sensor, real world 3D landmarks are projected onto an image plane to generate 2D locations of these landmarks on the RGBD sensor and the depth of these landmarks on the depth sensor. The camera measurement model is set forth in Equation (4) below.

$${z}_{l}^{IMG} = K [ R \vert t ] [ \begin{matrix}{x}_{l}^{w} \\ {y}_{l}^{w} \\ {z}_{l}^{w} \\ 1\end{matrix} ] + {n}_{feat} \qquad ( 4 )$$

The depth measurement model is set forth in Equation (5) below.

$${z}_{l}^{D P} = ( {\vert [ R \vert t ] [ \begin{matrix}{x}_{l}^{w} \\ {y}_{l}^{w} \\ {z}_{l}^{w} \\ 1\end{matrix} ] \vert}_{z} ) + {n}_{depth} \qquad ( 5 )$$

Herein, zₗ^{IMG} is a 2D location of landmark in an image frame, zₗ^{DP} is a depth of the landmark in a camera frame of reference, K is a camera intrinsic matrix. [R|t] is a pose matrix of the camera in a world frame reference,

$$[ \begin{matrix}{x}_{l}^{w} \\ {y}_{l}^{w} \\ {z}_{l}^{w} \\ 1\end{matrix} ]$$

is a 3D position of landmark 1 in a world frame of reference, and n_{feat} and n_{depth} are measurement noise, which is assumed as Gaussian noise.

For a given landmark l, frame i is set to the first frame that observes landmark l. Frame i is referred to as the anchor frame of landmark l. Zₗᵢ^{IMG}=[u̅ᵢ̅ₗ̅,v̅ᵢ̅ₗ̅]^{T} is set as the feature measurement of landmark 1 in frame i, and Zₗⱼ^{IMG}=[u̅ⱼ̅ₗ̅,v̅ⱼ̅ₗ̅]^{T} is set as the feature measurement of landmark l in a future frame j.

Since MSL-DVIO utilizes calibrated cameras, the feature measurement is stored in the normalized plane instead of the image plane. To compute this measurement the feature point is lifted from the image plane to a normalized plane using an inverse camera projection matrix, as set forth in Equation (6) below.

$$[ \begin{matrix}\overline{{x}_{l}} \\ \overline{{y}_{l}} \\ \overline{{z}_{l}}\end{matrix} ] = {π}^{- 1} ( {z}_{l}^{IMG} ) \qquad ( 6 )$$

Lens distortion is then handled by applying the distortion model recursively to the normalized feature measurement. The final feature measurement for a landmark in a camera frame is stored as set forth in Equation (7) below.

$${Z}_{l}^{IMG} = [ \begin{matrix}\overline{{u}_{l}} \\ \overline{{v}_{l}}\end{matrix} ] = [ \begin{matrix}\frac{\overline{{x}_{l}}}{\overline{{z}_{l}}} \\ \frac{\overline{{y}_{l}}}{\overline{{z}_{l}}}\end{matrix} ] \qquad ( 7 )$$

Since the landmark is estimated using the inverse depth of the feature in the anchor frame, this implementation of MSL-DVIO is referred to as MSL-DVIO 1D.

Using the feature measurement in frames i and j, the image residual for the feature in the non-anchor frame i is computed as set forth in Equation (8) below.

$${r}_{IMG} ( {x}_{i}^{R} , {x}_{j}^{R} , {λ}_{l} ) = g ( {T}_{c b} {T}_{{b}_{j} w} {T}_{{wb}_{i}} {{T}_{bc} [ \frac{\overline{{u}_{ι l}}}{{λ}_{l}} , \frac{\overline{{v}_{ι l}}}{{λ}_{l}} , \frac{1}{{λ}_{l}} , 1 ]}^{T} ) - {Z}_{lj}^{IMG} \qquad ( 8 )$$

Here,

$$g ( {[ X , Y , Z , 1 ]}^{T} ) = {[ \frac{X}{Z} , \frac{Y}{Z} ]}^{T} ,$$

$${T}_{b c} = [ \begin{matrix}{R}_{b c} & {p}_{c}^{b} \\ 0 & 1\end{matrix} ]$$

is the transformation from camera coordinate to IMU coordinate,

$${T}_{c b} = {T}_{b c}^{T} , {T}_{{b}_{j} w} = [ \begin{matrix}{R}_{{b}_{j} w} & {p}_{w}^{{b}_{j}} \\ 0 & 1\end{matrix} ]$$

is the robot pose for frame j, and

$${T}_{{b}_{i} w} = [ \begin{matrix}{R}_{{b}_{i} w} & {p}_{w}^{{b}_{i}} \\ 0 & 1\end{matrix} ]$$

is the robot pose for frame i, T_{wb}_{ᵢ}=T_{b}_{ᵢ}_{w}^{T}.

Similarly, in the depth map, the depth field of landmark l is measured, assuming that the camera and depth map are aligned in time and space. The estimated depth of the landmark in the anchor frame may be used to estimate the depth of the landmark in frame j. Thus, the depth residual is set forth in Equation (9) below.

$${r}_{DP} ( {x}_{i}^{R} , {x}_{j}^{R} , {λ}_{l} ) = {( {\vert {T}_{c b} {T}_{{b}_{j} w} {T}_{{wb}_{i}} {{T}_{bc} [ \frac{\overline{{u}_{ι l}}}{{λ}_{l}} , \frac{\overline{{v}_{ι l}}}{{λ}_{l}} , \frac{1}{{λ}_{l}} , 1 ]}^{T} \vert}_{z} )}^{- 1} - {Z}_{lj}^{DP} \qquad ( 9 )$$

Here, Zₗⱼ^{DP} is the inverse depth measurement of the landmark in the camera frame of reference given by

$${Z}_{lj}^{D P} = \frac{1}{{z}_{l}^{DP}} .$$

For simplicity, it may be assumed that the measurement noise for inverse depth measurement is also Gaussian.

Using the depth residue and image residue, the vision factor residue for a non-anchor frame is created by stacking the image and depth residue together, as set forth in Equation (10) below.

$${r}_{VIS}^{n o n} ( {x}_{i}^{R} , {x}_{j}^{R} , {λ}_{l} ) = [ \begin{matrix}{r}_{IMG} ( {x}_{i}^{R} , {x}_{j}^{R} , {λ}_{l} ) \\ {r}_{DP} ( {x}_{i}^{R} , {x}_{j}^{R} , {λ}_{l} )\end{matrix} ] \qquad ( 10 )$$

This residue is then used in the graph optimization to solve for the robot state using nonlinear optimization. In performing the optimization, the Jacobian of the residue is generated with respect to the state variable. To compute the Jacobian of the non-anchor frame vision residual, a landmark observation in the camera domain is defined as set forth in Equation (11) below.

$${p}_{l}^{{c}_{j}} = {[ {x}_{l}^{{c}_{j}} , {y}_{l}^{{c}_{j}} , {z}_{l}^{{c}_{j}} , 1 ]}^{T} = {T}_{c b} {T}_{{b}_{j} w} {T}_{{wb}_{i}} {{T}_{bc} [ \frac{\overline{{u}_{ι l}}}{{λ}_{l}} , \frac{\overline{{v}_{ι l}}}{{λ}_{l}} , \frac{1}{{λ}_{l}} , 1 ]}^{T} \qquad ( 11 )$$

The RGBD measurement of the feature is given by

$$f ( {p}_{l}^{{c}_{j}} ) = [ \begin{matrix}\begin{matrix}\frac{{x}_{l}^{{c}_{j}}}{{z}_{l}^{{c}_{j}}} \\ \frac{{y}_{l}^{{c}_{j}}}{{z}_{l}^{{c}_{j}}}\end{matrix} \\ \frac{1}{{z}_{l}^{{c}_{j}}}\end{matrix} ] ,$$

resulting in Equation (12) below.

$$\frac{\partial f ( {p}_{l}^{{c}_{j}} )}{\partial {p}_{l}^{{c}_{j}}} = [ \begin{matrix}\frac{1}{{z}_{l}^{{c}_{j}}} & 0 & - \frac{{x}_{l}^{{c}_{j}}}{{z}_{l}^{{{c}_{j}}^{2}}} \\ 0 & \frac{1}{{z}_{l}^{{c}_{j}}} & - \frac{{y}_{l}^{{c}_{j}}}{{z}_{l}^{{{c}_{j}}^{2}}} \\ 0 & 0 & \frac{- 1}{{z}_{l}^{{{c}_{j}}^{2}}}\end{matrix} ] \qquad ( 12 )$$

The Jacobian matrices of the vision residual may be calculated as set forth below.

The Jacobian of the vision residual with respect to the world position of anchor frame i, (3×3 matrix), is set forth below in Equation (13).

$$\frac{\partial {r}_{VIS}^{non} ( {x}_{i}^{R} , {x}_{j}^{R} , {λ}_{l} )}{\partial {p}_{{b}_{i}}^{w}} = \frac{\partial f ( {p}_{l}^{{c}_{j}} )}{\partial {p}_{l}^{{c}_{j}}} {R}_{cb} {R}_{{wb}_{j}}^{T} \qquad ( 13 )$$

The Jacobian of the vision residual with respect to the rotation of anchor frame i, (3×3 matrix), is set forth below in Equation (14).

$$\frac{\partial {r}_{VIS}^{non} ( {x}_{i}^{R} , {x}_{j}^{R} , {λ}_{l} )}{\partial {θ}_{i}} = - \frac{\partial f ( {p}_{l}^{{c}_{j}} )}{\partial {p}_{l}^{{c}_{j}}} {R}_{cb} {R}_{{wb}_{j}}^{T} {{R}_{{wb}_{i}} [ {p}_{l}^{{b}_{i}} ]}_{\times } \qquad ( 14 )$$

The Jacobian of the vision residual with respect to the world position of frame j, (3×3 matrix), is set forth below in Equation (15).

$$\frac{\partial {r}_{VIS}^{non} ( {x}_{i}^{R} , {x}_{j}^{R} , {λ}_{l} )}{\partial {p}_{{b}_{j}}^{w}} = - \frac{\partial f ( {p}_{l}^{{c}_{j}} )}{\partial {p}_{l}^{{c}_{j}}} {R}_{cb} {R}_{{wb}_{j}}^{T} \qquad ( 15 )$$

The Jacobian of the vision residual with respect to the rotation of frame j, (3×3 matrix), is set forth below in Equation (16).

$$\frac{\partial {r}_{VIS}^{non} ( {x}_{i}^{R} , {x}_{j}^{R} , {λ}_{l} )}{\partial {θ}_{j}} = \frac{\partial f ( {p}_{l}^{{c}_{j}} )}{\partial {p}_{l}^{{c}_{j}}} {{R}_{cb} [ {p}_{l}^{{b}_{j}} ]}_{\times } \qquad ( 16 )$$

The Jacobian of the vision residual with respect to the inverse depth of feature l, (3×1 matrix), is set forth below in Equation (17).

$$\frac{\partial {r}_{VIS}^{non} ( {x}_{i}^{R} , {x}_{j}^{R} , {λ}_{l} )}{\partial {λ}_{l}} = \frac{\partial f ( {p}_{l}^{{c}_{j}} )}{\partial {p}_{l}^{{c}_{j}}} {R}_{cb} {R}_{{wb}_{j}}^{T} {R}_{{wb}_{i}} {{R}_{bc} [ - \frac{\overline{{u}_{ι l}}}{{λ}_{l}^{2}} , \frac{\overline{{v}_{ι l}}}{{λ}_{l}^{2}} , \frac{1}{{λ}_{l}^{2}} ]}^{T} \qquad ( 17 )$$

In the above-described scenario, the depth measurement is used in the graph using the original measurement in anchor keyframe i and the measurement is propagated to keyframe j to compute the residue for the feature and depth measurement. In addition, a block may be added for the depth measurement in the anchor keyframe to provide a stronger constraint on the depth update.

In this case, the measurement model used is only the depth measurement, as set forth in Equation (18) below.

$${Z}_{l}^{DP} = {( {\vert [ R \vert p ] [ \begin{matrix}{x}_{l}^{w} \\ {y}_{l}^{w} \\ {z}_{l}^{w} \\ 1\end{matrix} ] \vert}_{z} )}^{- 1} + {n}_{depth} \qquad ( 18 )$$

Since there is no update on the 2D feature measurement, the residue for the feature measurement is zero, and the residue for adding the parameter is reduced to only the residue from the depth measurement, as set forth in Equation (19) below.

$${r}_{DP} ( {λ}_{l} ) = {( {\vert {[ \frac{\overline{{u}_{ι l}}}{{λ}_{l}} , \frac{\overline{{v}_{ι l}}}{{λ}_{l}} , \frac{1}{{λ}_{l}} , 1 ]}^{T} \vert}_{z} )}^{- 1} - {Z}_{1 i}^{DP} \qquad ( 19 )$$

This will make the Jacobian to the inverse depth of feature l, (3×1 matrix), as set forth in Equation (20) below.

$$\frac{\partial {r}_{DP} ( {λ}_{l} )}{\partial {λ}_{l}} = {[ 0 , 0 , 1 ]}^{T} \qquad ( 20 )$$

Many sensors that include RGBD and IMU sensors are unsynchronized. In this case, there is a small time offset between camera and IMU timestamps. This time offset is typically considered to be constant but unknown. To estimate the time offset online, the this time offset is modeled as set forth in Equation (21) below.

t_{IMU}=t_{CAM}+Δt (21)

Here, t_{IMU} is the IMU clock time, t_{CAM} is the camera clock time, and Δt is the time offset between the two clocks. The Δt is modeled as random walk, and optimized using the feature and depth measurement.

According to embodiments using MSL-DVIO, with the time offset at any given time, the camera time stamp is compensated to bring it to the IMU time stamp. For computing a feature measurement at any given time in future, the feature measurement may be propagated using a constant velocity motion model as set forth in Equation (22) below.

Z_{liTD}^{IMG}=Zₗᵢ^{IMG}−(Δt−Δtᵢ+TRᵢ)Vₗᵢ^{IMG} (22)

Where, Z_{liTD}^{IMG} is the time offset-compensated 2D measurement of landmark l in frame i, Zₗᵢ^{IMG} is the original 2D measurement of landmark l in frame i, Δt is the current estimate of time offset, Δtᵢ is the estimate of the time offset when the camera frame i was processed, and Vₗᵢ^{IMG} is the 2D velocity of the feature computed during feature tracking.

TRᵢ is the time offset arising from rolling shutter camera which is set forth in Equation (23) below.

$${TR}_{i} = \frac{TR}{ROW} {ROW}_{i} \qquad ( 23 )$$

Where, TR is the rolling shutter read out time, ROW is the total number of row in the frame, and OWᵢ is the row in which feature is observed.

Similarly, a feature measurement for the depth is set forth in Equation (24) below.

z_{liTD}^{DP}=zₗᵢ^{DP}−(Δt−Δtᵢ+TRᵢ)Vₗᵢ^{DP} (24)

Vₗᵢ^{DP} is the rate of change of the feature depth in the depth map, as set forth in Equation (25) below.

Vₗᵢ^{DP}=(zₗᵢ^{DP}−zₗ₍ᵢ₋₁₎^{DP})/dt (25)

Using this new measurement, the residue is computed as set forth in Equations (26), (27), and (28) below.

$${r}_{VIS}^{TD} ( {x}_{i}^{R} , {x}_{j}^{R} , {λ}_{l} ) = [ \begin{matrix}{r}_{IMG}^{TD} ( {x}_{i}^{R} , {x}_{j}^{R} , {λ}_{l} ) \\ {r}_{DP}^{TD} ( {x}_{i}^{R} , {x}_{j}^{R} , {λ}_{l} )\end{matrix} ] \qquad ( 26 )$$

$${r}_{IMG}^{TD} ( {x}_{i}^{R} , {x}_{j}^{R} , {λ}_{l} ) = g ( {T}_{cb} {T}_{{b}_{j} w} {T}_{{wb}_{i}} {{T}_{bc} [ \frac{\overline{{u}_{ι lTD}}}{{λ}_{l}} , \frac{\overline{{v}_{ι lTD}}}{{λ}_{l}} , \frac{1}{{λ}_{l}} , 1 ]}^{T} ) - {Z}_{1 jTD}^{IMG} \qquad ( 27 )$$

$${r}_{DP}^{TD} ( {x}_{i}^{R} , {x}_{j}^{R} , {λ}_{l} ) = {( {\vert {T}_{cb} {T}_{{b}_{j} w} {T}_{{wb}_{i}} {{T}_{bc} [ \frac{\overline{{u}_{ι lTD}}}{{λ}_{l}} , \frac{\overline{{v}_{ι lTD}}}{{λ}_{l}} , \frac{1}{{λ}_{l}} , 1 ]}^{T} \vert}_{z} )}^{- 1} - \frac{1}{{z}_{1 jTD}^{DP}} \qquad ( 28 )$$

Similar to that described above, a landmark observation in the camera domain is defined as set forth in Equation (29) below.

$${p}_{lTD}^{{c}_{j}} = {[ {x}_{lTD}^{{c}_{j}} , {y}_{lTD}^{{c}_{j}} , {z}_{lTD}^{{c}_{j}} , 1 ]}^{T} = {T}_{cb} {T}_{{b}_{j} w} {T}_{{wb}_{i}} {{T}_{bc} [ \frac{\overline{{u}_{ι lTD}}}{{λ}_{l}} , \frac{\overline{{v}_{ι lTD}}}{{λ}_{l}} , \frac{1}{{λ}_{l}} , 1 ]}^{T} \qquad ( 29 )$$

The RGBD measurement of the feature is given by

$$f ( {p}_{lTD}^{{c}_{j}} ) = [ \begin{matrix}\frac{{x}_{lTD}^{{c}_{j}}}{{z}_{lTD}^{{c}_{j}}} \\ \frac{{y}_{l}^{{c}_{j}}}{{z}_{lTD}^{{c}_{j}}} \\ \frac{1}{{z}_{lTD}^{{c}_{j}}}\end{matrix} ] .$$

With the new residue, the Jacobian matrices of the vision residual can be calculated as set forth below.

The Jacobian of the vision residual with respect to the world position of anchor frame i, (3×3 matrix), is set forth in Equation (30) below.

$$\frac{\partial {r}_{VIS}^{TD} ( {x}_{i}^{R} , {x}_{j}^{R} , {λ}_{l} )}{\partial {p}_{{b}_{i}}^{w}} = \frac{\partial f ( {p}_{lTD}^{{c}_{j}} )}{\partial {p}_{lTD}^{{c}_{j}}} {R}_{cb} {R}_{{wb}_{j}}^{T} \qquad ( 30 )$$

The Jacobian of the vision residual with respect to the rotation of anchor frame i, (3×3 matrix), is set forth in Equation (31) below.

$$\frac{\partial {r}_{VIS}^{TD} ( {x}_{i}^{R} , {x}_{j}^{R} , {λ}_{l} )}{\partial {θ}_{i}} = - \frac{\partial f ( {p}_{lTD}^{{c}_{j}} )}{\partial {p}_{lTD}^{{c}_{j}}} {R}_{cb} {R}_{{wb}_{j}}^{T} {{{R}_{wb}}_{i} [ {p}_{lTD}^{{b}_{i}} ]}_{\times } \qquad ( 31 )$$

The Jacobian of the vision residual with respect to the world position of frame j, (3×3 matrix), is set forth in Equation (32) below.

$$\frac{\partial {r}_{VIS}^{TD} ( {x}_{i}^{R} , {x}_{j}^{R} , {λ}_{l} )}{\partial {p}_{{b}_{j}}^{w}} = - \frac{\partial f ( {p}_{lTD}^{{c}_{j}} )}{\partial {p}_{lTD}^{{c}_{j}}} {R}_{cb} {R}_{{wb}_{j}}^{T} \qquad ( 32 )$$

The Jacobian of the vision residual with respect to the rotation of frame j, (3×3 matrix), is set forth in Equation (33) below.

$$\frac{\partial {r}_{V I S}^{T D} ( {x}_{i}^{R} , {x}_{j}^{R} , {λ}_{l} )}{\partial {θ}_{j}} = \frac{\partial f ( {p}_{l}^{{c}_{j}} )}{\partial {p}_{l}^{{c}_{j}}} {{R}_{c b} [ {p}_{l T D}^{{b}_{j}} ]}_{\times } \qquad ( 33 )$$

The Jacobian of the vision residual with respect to the inverse depth of feature l, (3×1 matrix), is set forth in Equation (34) below.

$$\frac{\partial {r}_{V I S}^{T D} ( {x}_{i}^{R} , {x}_{j}^{R} , {λ}_{l} )}{\partial {λ}_{l}} = \frac{\partial f ( {p}_{l}^{{c}_{j}} )}{\partial {p}_{l}^{{c}_{j}}} {R}_{c b} {R}_{w {b}_{j}}^{T} {R}_{w {b}_{i}} {{R}_{b c} [ - \frac{\overline{{u}_{ι l T D}}}{{λ}_{l}^{2}} , - \frac{\overline{{v}_{ι l T D}}}{{λ}_{l}^{2}} , - \frac{1}{{λ}_{l}^{2}} ]}^{T} \qquad ( 34 )$$

The Jacobian of the vision residual with respect to the time offset, (3×1 matrix), is set forth in Equation (35) below.

$$\frac{\partial {r}_{V I S}^{T D} ( {x}_{i}^{R} , {x}_{j}^{R} , {λ}_{l} )}{\partial Δ t} = \frac{\partial f ( {p}_{l T D}^{{c}_{j}} )}{\partial {p}_{l T D}^{{c}_{j}}} \frac{- 1}{{λ}_{l}} {R}_{c b} {R}_{w {b}_{j}}^{T} {R}_{w {b}_{i}} {R}_{b c} [ \begin{matrix}{V}_{l i}^{I M G} \\ 0\end{matrix} ] + [ \begin{matrix}{V}_{l j}^{I M G} \\ 0\end{matrix} ] \qquad ( 35 )$$

The Jacobian of the vision residual with respect to the inverse depth in anchor frame, (3×1 matrix), is set forth in Equation (36) below.

$$\frac{\partial {r}_{D P} ( {λ}_{l} )}{\partial {λ}_{l}} = {[ 0 , 0 , 1 ]}^{T} \qquad ( 36 )$$

In the VINS-Mono, the feature is parameterized using the inverse depth in the anchor keyframe. Thus, the feature measurement in the anchor frame is not able to be used as a residue for performing graph optimization. To enable the feature measurement in the anchor frame to be used as a residue in the graph optimization problem, the 2D location of the feature in the anchor is added as part of the feature state, converting the feature state parameterization to 3D. This new state of the sliding window is set forth in Equation (37) below.

X=[x^{nav}; x^{feat}] (37)

Where, x^{nav}=[x₀^{hac}; x₁^{nav}; . . . ; xₙ^{nav}] with

$${x}_{k}^{n a v} = [ \begin{matrix}{x}_{k}^{R} \\ {x}_{k}^{S B}\end{matrix} ] ,$$

pose, speed, and bias for k^{th} keyframes, x^{feat}=[f₀ . . . fₘ], f₁=[u₁,v₁,λ₁], (u₁, v₁) is the estimate of the 2D location of the feature in anchor frame, and λ₁ is the estimate of inverse depth of the feature in anchor frame.

Since the landmark is estimated using the full 3D location of the feature in the anchor frame, this implementation of MSL-DVIO is referred to as MSL-DVIO 3D.

With the above-described 3D feature parameterization, the vision residue can be computed for both anchor and non-anchor frames.

For the non-anchor frame, the estimate of the 3D feature in the anchor frame is used to project in the non-anchor frame to compute residues, as set forth in Equations (38), (39), and (40) below.

$${r}_{V I S}^{n o n} ( {x}_{i}^{R} , {x}_{j}^{R} , {f}_{l} ) = [ \begin{matrix}{r}_{I M G} ( {x}_{i}^{R} , {x}_{j}^{R} , {f}_{l}^{c} ) \\ {r}_{D P} ( {x}_{i}^{R} , {x}_{j}^{R} , {f}_{l}^{c} )\end{matrix} ] \qquad ( 38 )$$

$${r}_{I M G} ( {x}_{i}^{R} , {x}_{j}^{R} , {f}_{l} ) = g ( {T}_{c b} {T}_{{b}_{j} w} {T}_{w {b}_{i}} {{T}_{b c} [ \frac{{u}_{i l}}{{λ}_{l}} , \frac{{v}_{i l}}{{λ}_{l}} , \frac{1}{{λ}_{l}} , 1 ]}^{T} ) - {Z}_{l j}^{I M G} \qquad ( 39 )$$

$${r}_{D P} ( {x}_{i}^{R} , {x}_{j}^{R} , {f}_{l} ) = {( {\vert {T}_{c b} {T}_{{b}_{j} w} {T}_{w {b}_{i}} {{T}_{b c} [ \frac{{u}_{i l}}{{λ}_{l}} , \frac{{v}_{i l}}{{λ}_{l}} , \frac{1}{{λ}_{l}} , 1 ]}^{T} \vert}_{z} )}^{- 1} - {Z}_{l j}^{D P} \qquad ( 40 )$$

Similarly, the vision residue for the anchor frame is computed using the 3D estimate of the feature in the anchor frame, as set forth in Equations (41), (42), and (43) below.

$${r}_{V I S}^{anchor} ( {u}_{i l} , {v}_{i l} , {λ}_{l} ) = [ \begin{matrix}{r}_{anchor} ( {u}_{i l} , {v}_{i l} ) \\ {r}_{anchor} ( {λ}_{l} )\end{matrix} ] \qquad ( 41 )$$

$${r}_{anchor} ( {u}_{i l} , {v}_{i l} ) = {[ {u}_{i l} , {v}_{i l} ]}^{T} - {Z}_{l i}^{I M G} \qquad ( 42 )$$

$${r}_{anchor} ( {λ}_{l} ) = {λ}_{l} - {Z}_{l i}^{D P} \qquad ( 43 )$$

Similar to that described-above, the Jacobian for 3D parameterization is computed by using the 2D estimated value of the feature from state, as set forth in Equation (44) below.

$${p}_{l 3 D}^{{c}_{j}} = {[ {x}_{l 3 D}^{{c}_{j}} , {y}_{l 3 D}^{{c}_{j}} , {z}_{l 3 D}^{{c}_{j}} , 1 ]}^{T} = {T}_{c b} {T}_{{b}_{j} w} {T}_{w {b}_{i}} {{T}_{b c} [ \frac{{u}_{i l}}{{λ}_{l}} , \frac{{v}_{i l}}{{λ}_{l}} , \frac{1}{{λ}_{l}} , 1 ]}^{T} \qquad ( 44 )$$

The RGBD measurement of the feature is given by

$$f ( {p}_{l 3 D}^{{c}_{j}} ) = [ \begin{matrix}\frac{{x}_{l 3 D}^{{c}_{j}}}{{z}_{l 3 D}^{{c}_{j}}} \\ \frac{{y}_{l 3 D}^{{c}_{j}}}{{z}_{l 3 D}^{{c}_{j}}} \\ \frac{1}{{z}_{l 3 D}^{{c}_{j}}}\end{matrix} ] ,$$

resulting in Equation (45) below.

$$\frac{\partial f ( {p}_{l 3 D}^{{c}_{j}} )}{\partial {p}_{l 3 D}^{{c}_{j}}} = [ \begin{matrix}\frac{1}{{z}_{l 3 D}^{{c}_{j}}} & 0 & - \frac{{x}_{l 3 D}^{{c}_{j}}}{{z}_{l 3 D}^{{c}_{j}^{2}}} \\ 0 & \frac{1}{{z}_{l 3 D}^{{c}_{j}}} & - \frac{{y}_{l 3 D}^{{c}_{j}}}{{z}_{l 3 D}^{{c}_{j}^{2}}} \\ 0 & 0 & - \frac{- 1}{{z}_{l 3 D}^{{c}_{j}^{2}}}\end{matrix} ] \qquad ( 45 )$$

The Jacobian of the vision residual with respect to the world position of anchor frame i, (3×3 matrix), is set forth in Equation (46) below.

$$\frac{\partial {r}_{V I S}^{n o n} ( {x}_{i}^{R} , {x}_{j}^{R} , {f}_{l} )}{\partial {p}_{{b}_{i}}^{w}} = \frac{\partial f ( {p}_{l 3 D}^{{c}_{j}} )}{\partial {p}_{l 3 D}^{{c}_{j}}} {R}_{c b} {R}_{w {b}_{j}}^{T} \qquad ( 46 )$$

The Jacobian of the vision residual with respect to the rotation of anchor frame i, (3×3 matrix), is set forth in Equation (47) below.

$$\frac{\partial {r}_{V I S}^{n o n} ( {x}_{i}^{R} , {x}_{j}^{R} , {f}_{l} )}{\partial {θ}_{i}} = - \frac{\partial f ( {p}_{l 3 D}^{{c}_{j}} )}{\partial {p}_{l 3 D}^{{c}_{j}}} {R}_{c b} {R}_{w {b}_{j}}^{T} {{R}_{w {b}_{i}} [ {p}_{l 3 D}^{{b}_{i}} ]}_{\times } \qquad ( 47 )$$

The Jacobian of the vision residual with respect to the world position of frame j, (3×3 matrix), is set forth in Equation (48) below.

$$\frac{\partial {r}_{V I S}^{n o n} ( {x}_{i}^{R} , {x}_{j}^{R} , {f}_{l} )}{\partial {p}_{{b}_{j}}^{w}} = - \frac{\partial f ( {p}_{l 3 D}^{{c}_{j}} )}{\partial {p}_{l 3 D}^{{c}_{j}}} {R}_{c b} {R}_{w {b}_{j}}^{T} \qquad ( 48 )$$

The Jacobian of the vision residual with respect to the rotation of frame j, (3×3 matrix), is set forth in Equation (49) below.

$$\frac{\partial {r}_{V I S}^{n o n} ( {x}_{i}^{R} , {x}_{j}^{R} , {f}_{l} )}{\partial {θ}_{j}} = \frac{\partial f ( {p}_{l 3 D}^{{c}_{j}} )}{\partial {p}_{l 3 D}^{{c}_{j}}} {{R}_{c b} [ {p}_{l 3 D}^{{b}_{j}} ]}_{\times } \qquad ( 49 )$$

By making the 3D parametrization of the feature in state, the Jacobian of the residue with respect to the feature will change to a 3×3 matrix as described below.

The Jacobian for the non-anchor frame is set forth in Equations (50), (51), and (52) below.

$$\frac{\partial {r}_{V I S}^{n o n} ( {x}_{i}^{R} , {x}_{j}^{R} , {f}_{l} )}{\partial {u}_{i l}} = \frac{\partial f ( {p}_{l 3 D}^{{c}_{j}} )}{\partial {p}_{l 3 D}^{{c}_{j}}} {R}_{c b} {R}_{w {b}_{j}}^{T} {R}_{w {b}_{i}} {{R}_{b c} [ \frac{1}{{λ}_{l}} , 0 , 0 ]}^{T} \qquad ( 50 )$$

$$\frac{\partial {r}_{V I S}^{n o n} ( {x}_{i}^{R} , {x}_{j}^{R} , {f}_{l} )}{\partial {v}_{i l}} = \frac{\partial f ( {p}_{l 3 D}^{{c}_{j}} )}{\partial {p}_{l 3 D}^{{c}_{j}}} {R}_{c b} {R}_{w {b}_{j}}^{T} {R}_{w {b}_{i}} {{R}_{b c} [ 0 , \frac{1}{{λ}_{l}} , 0 ]}^{T} \qquad ( 51 )$$

$$\frac{\partial {r}_{V I S}^{n o n} ( {x}_{i}^{R} , {x}_{j}^{R} , {f}_{l} )}{\partial {λ}_{l}} = \frac{\partial f ( {p}_{l 3 D}^{{c}_{j}} )}{\partial {p}_{l 3 D}^{{c}_{j}}} {R}_{c b} {R}_{w {b}_{j}}^{T} {R}_{w {b}_{i}} {{R}_{b c} [ - \frac{{u}_{i l}}{{λ}_{l}^{2}} , - \frac{{v}_{i l}}{{λ}_{l}^{2}} , - \frac{1}{{λ}_{l}^{2}} ]}^{T} \qquad ( 52 )$$

The Jacobian for the anchor frame is set forth in Equations (53), (54), and (55) below.

$$\frac{\partial {r}_{VIS}^{anchor} ( {u}_{il} , {v}_{il} , {λ}_{l} )}{\partial {u}_{il}} = {[ 1 , 0 , 0 ]}^{T} \qquad ( 53 )$$

$$\frac{\partial {r}_{VIS}^{anchor} ( {u}_{il} , {v}_{il} , {λ}_{l} )}{\partial {v}_{il}} = {[ 0 , 1 , 0 ]}^{T} \qquad ( 54 )$$

$$\frac{\partial {r}_{VIS}^{anchor} ( {u}_{il} , {v}_{il} , {λ}_{l} )}{\partial {λ}_{l}} = {[ 0 , 0 , 1 ]}^{T} \qquad ( 55 )$$

As described above, 3D feature parameterization adds full 3D feature measurements in the anchor frame as part of the anchor frame residue for graph optimization.

Similar to the time offset estimation process for MSL-DVIO 1D, time offset corrected measurement of the 3D location of the feature may be computed. The 2D location of the feature may be estimated using the time offset estimation similar to MSL-DVIO 1D, except that the estimated value of Equation (56) is used.

Z_{l3DiTD}^{IMG}=Zₗᵢ^{IMG}−(Δt−Δtᵢ+TRᵢ)Vₗᵢ^{IMG} (56)

Similarly, for depth measurement, the time offset corrected measurement may be computed as described in MSL-DVIO 1D, as set forth below in Equation (57).

Z_{l3DiTD}^{DP}=zₗᵢ^{DP}−(Δt−Δtᵢ+TRᵢ)Vₗᵢ^{DP} (57)

Using the new measurement, the residue for the non-anchor frame may be computed, as set forth in Equations (58), (59), and (60) below.

$${r}_{VIS}^{T D} ( {x}_{i}^{R} , {x}_{j}^{R} , {f}_{l} ) = [ \begin{matrix}{r}_{IMG}^{T D} ( {x}_{i}^{R} , {x}_{j}^{R} , {f}_{l} ) \\ {r}_{D P}^{T D} ( {x}_{i}^{R} , {x}_{j}^{R} , {f}_{l} )\end{matrix} ] \qquad ( 58 )$$

$${r}_{IMG}^{T D} ( {x}_{i}^{R} , {x}_{j}^{R} , {f}_{l} ) = g ( {T}_{c b} {T}_{{b}_{j} w} {T}_{{wb}_{i}} {{T}_{bc} [ \frac{{u}_{i l T D}}{{λ}_{l}} , \frac{{v}_{i l T D}}{{λ}_{l}} , \frac{1}{{λ}_{l}} , 1 ]}^{T} ) - {Z}_{l 3 DjTD}^{IMG} \qquad ( 59 )$$

$${r}_{D P}^{T D} ( {x}_{i}^{R} , {x}_{j}^{R} , {f}_{l} ) = {( {\vert {T}_{c b} {T}_{{b}_{j} w} {T}_{{wb}_{i}} {{T}_{bc} [ \frac{{u}_{i l T D}}{{λ}_{l}} , \frac{{v}_{i l T D}}{{λ}_{l}} , \frac{1}{{λ}_{l}} , 1 ]}^{T} \vert}_{z} )}^{- 1} - \frac{1}{{Z}_{l 3 DjTD}^{DP}} \qquad ( 60 )$$

Similarly, for the anchor frame, the residue is set forth in Equations (61), (62), and (63) below.

$${r}_{VIS}^{T D anchor} ( {u}_{il} , {v}_{il} , {λ}_{l} ) = [ \begin{matrix}{r}_{anchor}^{TD} ( {u}_{il} , {v}_{il} ) \\ {r}_{anchor}^{TD} ( {λ}_{l} )\end{matrix} ] \qquad ( 61 )$$

$${r}_{a n chor}^{T D} ( {u}_{i l} , {v}_{i l} ) = {[ {u}_{i l} , {v}_{i l} ]}^{T} - {Z}_{l 3 D i T D}^{IMG} \qquad ( 62 )$$

$${r}_{anchor}^{T D} ( {λ}_{l} ) = {λ}_{l} - {Z}_{l 3 D i T D}^{D P} \qquad ( 63 )$$

The Jacobian for this system is computed as described below.

The Jacobian of the vision residual with respect to the world position of anchor frame i, (3×3 matrix), is set forth in Equation (64) below.

$$\frac{\partial {r}_{VIS}^{T D} ( {x}_{i}^{R} , {x}_{j}^{R} , {f}_{l} )}{\partial {p}_{{b}_{i}}^{w}} = \frac{\partial f ( {p}_{l 3 D T D}^{{c}_{j}} )}{\partial {p}_{l 3 D T D}^{{c}_{j}}} {R}_{c b} {R}_{w {b}_{j}}^{T} \qquad ( 64 )$$

The Jacobian of the vision residual with respect to the rotation of anchor frame i, (3×3 matrix), is set forth in Equation (65) below.

$$\frac{\partial {r}_{VIS}^{T D} ( {x}_{i}^{R} , {x}_{j}^{R} , {f}_{l} )}{\partial {θ}_{i}} = - \frac{\partial f ( {p}_{l 3 D T D}^{{c}_{j}} )}{\partial {p}_{l 3 D T D}^{{c}_{j}}} {R}_{c b} {R}_{w {b}_{j}}^{T} {{R}_{w {b}_{i}} [ {p}_{l 3 D}^{{b}_{i}} ]}_{\times } \qquad ( 65 )$$

The Jacobian of the vision residual with respect to the world position of frame j, (3×3 matrix), is set forth in Equation (66) below.

$$\frac{\partial {r}_{VIS}^{T D} ( {x}_{i}^{R} , {x}_{j}^{R} , {f}_{l} )}{\partial {p}_{{b}_{j}}^{w}} = - \frac{\partial f ( {p}_{l 3 D T D}^{{c}_{j}} )}{\partial {p}_{l 3 D T D}^{{c}_{j}}} {R}_{c b} {R}_{w {b}_{j}}^{T} \qquad ( 66 )$$

The Jacobian of the vision residual with respect to the rotation of frame j, (3×3 matrix), is set forth in Equation (67) below.

$$\frac{\partial {r}_{VIS}^{T D} ( {x}_{i}^{R} , {x}_{j}^{R} , {f}_{l} )}{\partial {θ}_{j}} = \frac{\partial f ( {p}_{l 3 D T D}^{{c}_{j}} )}{\partial {p}_{l 3 D T D}^{{c}_{j}}} {{R}_{c b} [ {p}_{l 3 D}^{{b}_{j}} ]}_{\times } \qquad ( 67 )$$

By making the 3D parametrization of the feature in state, the Jacobian of the residue with respect to the feature will change to a 3×3 matrix, as described below.

The Jacobian for the non-anchor frame is set forth in Equations (68), (69), and (70) below.

$$\frac{\partial {r}_{VIS}^{T D} ( {x}_{i}^{R} , {x}_{j}^{R} , {f}_{l} )}{\partial {u}_{i l}} = \frac{\partial f ( {p}_{l 3 D T D}^{{c}_{j}} )}{\partial {p}_{l 3 D T D}^{{c}_{j}}} {R}_{c b} {R}_{w {b}_{j}}^{T} {R}_{w {b}_{i}} {{R}_{b c} [ \frac{1}{{λ}_{l}} , 0 , 0 ]}^{T} \qquad ( 68 )$$

$$\frac{\partial {r}_{VIS}^{T D} ( {x}_{i}^{R} , {x}_{j}^{R} , {f}_{l} )}{\partial {v}_{i l}} = \frac{\partial f ( {p}_{l 3 D T D}^{{c}_{j}} )}{\partial {p}_{l 3 D T D}^{{c}_{j}}} {R}_{c b} {R}_{w {b}_{j}}^{T} {R}_{w {b}_{i}} {{R}_{b c} [ 0 , \frac{1}{{λ}_{l}} , 0 ]}^{T} \qquad ( 69 )$$

$$\frac{\partial {r}_{VIS}^{T D} ( {x}_{i}^{R} , {x}_{j}^{R} , {f}_{l} )}{\partial {λ}_{l}} = \frac{\partial f ( {p}_{l 3 D T D}^{{c}_{j}} )}{\partial {p}_{l 3 D T D}^{{c}_{j}}} {R}_{c b} {R}_{w {b}_{j}}^{T} {R}_{w {b}_{i}} {{R}_{b c} [ - \frac{{u}_{ilTD}}{{λ}_{l}^{2}} , - \frac{{v}_{ilTD}}{{λ}_{l}^{2}} , - \frac{1}{{λ}_{l}^{2}} ]}^{T} \qquad ( 70 )$$

The Jacobian for the anchor frame is set forth in Equations (71), (72), and (73) below.

$$\frac{\partial {r}_{VIS}^{T D anchor} ( {u}_{il} , {v}_{il} , {f}_{l} )}{\partial {u}_{il}} = {[ 1 , 0 , 0 ]}^{T} \qquad ( 71 )$$

$$\frac{\partial {r}_{VIS}^{T D anchor} ( {u}_{il} , {v}_{il} , {f}_{l} )}{\partial {v}_{il}} = {[ 0 , 1 , 0 ]}^{T} \qquad ( 72 )$$

$$\frac{\partial {r}_{VIS}^{T D anchor} ( {u}_{il} , {v}_{il} , {f}_{l} )}{\partial {λ}_{l}} = {[ 0 , 0 , 1 ]}^{T} \qquad ( 73 )$$

The Jacobian of the vision residual with respect to the time offset, (3×1 matrix), is set forth in Equation (74) below.

$$\frac{\partial {r}_{VIS}^{n o n} ( {x}_{i}^{R} , {x}_{j}^{R} , {f}_{l} )}{\partial Δ t} = \frac{\partial f ( {p}_{l 3 D T D}^{{c}_{j}} )}{\partial {p}_{l 3 D T D}^{{c}_{j}}} \frac{- 1}{{λ}_{l}} {R}_{c b} {R}_{w {b}_{j}}^{T} {R}_{w {b}_{i}} {R}_{b c} [ \begin{matrix}{V}_{l i}^{IMG} \\ 0\end{matrix} ] + [ \begin{matrix}{V}_{lj}^{IMG} \\ 0\end{matrix} ] \qquad ( 74 )$$

In Table 2 and Table 3, system residue and Jacobian comparison of the MSL-DVIO are provided for all combinations described above.

TABLE 2
MSL-DVIO Residue and Jacobian without Time Offset

| | ID Feature Parameter | 3D featuer Parameter |
|---|---|---|
| Image Residue (Non- | $g ( {T}_{cb} {T}_{{b}_{j} w} {T}_{{wb}_{i}} {{T}_{bc} [ \frac{\overline{{u}_{il}}}{{λ}_{l}} , \frac{\overline{{v}_{il}}}{{λ}_{l}} , \frac{1}{{λ}_{l}} , 1 ]}^{T} ) - {Z}_{lj}^{IMG}$ | $g ( {T}_{cb} {T}_{{b}_{j} w} {T}_{{wb}_{i}} {{T}_{bc} [ \frac{{u}_{il}}{{λ}_{l}} , \frac{{v}_{il}}{{λ}_{l}} , \frac{1}{{λ}_{l}} , 1 ]}^{T} ) - {Z}_{lj}^{IMG}$ |
| Anchor) | | |
| Depth Residue (Non- | ${( {\vert {T}_{cb} {T}_{{b}_{j} w} {T}_{{wb}_{i}} {{T}_{bc} [ \frac{\overline{{u}_{il}}}{{λ}_{l}} , \frac{\overline{{v}_{il}}}{{λ}_{l}} , \frac{1}{{λ}_{l}} , 1 ]}^{T} \vert}_{z} )}^{- 1} - {Z}_{lj}^{DP}$ | ${( {\vert {T}_{cb} {T}_{{b}_{j} w} {T}_{{wb}_{i}} {{T}_{bc} [ \frac{{u}_{il}}{{λ}_{l}} , \frac{{v}_{il}}{{λ}_{l}} , \frac{1}{{λ}_{l}} , 1 ]}^{T} \vert}_{z} )}^{- 1} - {Z}_{lj}^{DP}$ |
| Anchor) | | |
| Image | N/A | [uᵢₗ, vᵢₗ]^{T} − Zₗᵢ^{IMG} |
| Residue | | |
| (Anchor) | | |
| Depth Residue (Anchor) | ${( {\vert {[ \frac{\overline{{u}_{il}}}{{λ}_{l}} , \frac{\overline{{v}_{il}}}{{λ}_{l}} , \frac{1}{{λ}_{l}} , 1 ]}^{T} \vert}_{z} )}^{- 1} - {Z}_{li}^{DP}$ | λₗ − Zₗᵢ^{DP} |
| Jacobian (Anchor Pose) | $\frac{\partial {r}_{VIS}^{non} ( {x}_{i}^{R} , {x}_{j}^{R} , {λ}_{l} )}{\partial {p}_{{b}_{i}}^{w}} = \frac{\partial f ( {p}_{l}^{{c}_{j}} )}{\partial {p}_{l}^{{c}_{j}}} {R}_{cb} {R}_{{wb}_{j}}^{T}$ | $\frac{\partial {r}_{VIS}^{non} ( {x}_{i}^{R} , {x}_{j}^{R} , {f}_{l} )}{\partial {p}_{{b}_{i}}^{w}} = \frac{\partial f ( {p}_{l 3 D}^{{c}_{j}} )}{\partial {p}_{l 3 D}^{{c}_{j}}} {R}_{cb} {R}_{{wb}_{j}}^{T}$ |
| Jacobian (Anchor Rotation) | $\frac{\partial {r}_{VIS}^{non} ( {x}_{i}^{R} , {x}_{j}^{R} , {λ}_{l} )}{\partial {θ}_{i}} = - \frac{\partial f ( {p}_{l}^{{c}_{j}} )}{\partial {p}_{l}^{{c}_{j}}} {R}_{cb} {R}_{{wb}_{j}}^{T} {{R}_{{wb}_{i}} [ {p}_{l}^{{b}_{i}} ]}_{\times }$ | $\frac{\partial {r}_{VIS}^{non} ( {x}_{i}^{R} , {x}_{j}^{R} , {f}_{l} )}{\partial {θ}_{i}} = - \frac{\partial f ( {p}_{l 3 D}^{{c}_{j}} )}{\partial {p}_{l 3 D}^{{c}_{j}}} {R}_{cb} {R}_{{wb}_{j}}^{T} {{R}_{{wb}_{i}} [ {p}_{l 3 D}^{{b}_{i}} ]}_{\times }$ |
| Jacobian (Non Anchor Pose) | $\frac{\partial {r}_{VIS}^{non} ( {x}_{i}^{R} , {x}_{j}^{R} , {λ}_{l} )}{\partial {p}_{{b}_{j}}^{w}} = - \frac{\partial f ( {p}_{l}^{{c}_{j}} )}{\partial {p}_{l}^{{c}_{j}}} {R}_{cb} {R}_{{wb}_{j}}^{T}$ | $\frac{\partial {r}_{VIS}^{non} ( {x}_{i}^{R} , {x}_{j}^{R} , {f}_{l} )}{\partial {p}_{{b}_{j}}^{w}} = - \frac{\partial f ( {p}_{l 3 D}^{{c}_{j}} )}{\partial {p}_{l 3 D}^{{c}_{j}}} {R}_{cb} {R}_{{wb}_{j}}^{T}$ |
| Jacobian (Non Anchor | $\frac{\partial {r}_{VIS}^{non} ( {x}_{i}^{R} , {x}_{j}^{R} , {λ}_{l} )}{\partial {θ}_{j}} = \frac{\partial f ( {p}_{l}^{{c}_{j}} )}{\partial {p}_{l}^{{c}_{j}}} {{R}_{c b} [ {p}_{l}^{{b}_{j}} ]}_{\times }$ | $\frac{\partial {r}_{VIS}^{non} ( {x}_{i}^{R} , {x}_{j}^{R} , {f}_{l} )}{\partial {θ}_{j}} = \frac{\partial f ( {p}_{l 3 D}^{{c}_{j}} )}{\partial {p}_{l 3 D}^{{c}_{j}}} {{R}_{c b} [ {p}_{l 3 D}^{{b}_{j}} ]}_{\times }$ |
| Rotation) | | |
| Jacobian (Non anchor Feature) | $\frac{\partial {r}_{VIS}^{non} ( {x}_{i}^{R} , {x}_{j}^{R} , {λ}_{l} )}{\partial {λ}_{l}} = \\ \frac{\partial f ( {p}_{l}^{{c}_{j}} )}{\partial {p}_{l}^{{c}_{j}}} {R}_{cb} {R}_{{wb}_{j}}^{T} {R}_{{wb}_{i}} {{R}_{bc} [ - \frac{\overline{{u}_{il}}}{{λ}_{l}^{2}} , - \frac{\overline{{v}_{il}}}{{λ}_{l}^{2}} , - \frac{1}{{λ}_{l}^{2}} ]}^{T}$ | $\frac{\partial {r}_{VIS}^{non} ( {x}_{i}^{R} , {x}_{j}^{R} , {f}_{l} )}{\partial {u}_{il}} = \\ \frac{\partial f ( {p}_{l 3 D}^{{c}_{j}} )}{\partial {p}_{l 3 D}^{{c}_{j}}} {R}_{cb} {R}_{{wb}_{j}}^{T} {R}_{{wb}_{i}} {{R}_{bc} [ \frac{1}{{λ}_{l}} , 0 , 0 ]}^{T}$ |
| | | $\frac{\partial {r}_{VIS}^{non} ( {x}_{i}^{R} , {x}_{j}^{R} , {f}_{l} )}{\partial {v}_{il}} = \\ \frac{\partial f ( {p}_{l 3 D}^{{c}_{j}} )}{\partial {p}_{l 3 D}^{{c}_{j}}} {R}_{cb} {R}_{{wb}_{j}}^{T} {R}_{{wb}_{i}} {{R}_{bc} [ 0 , \frac{1}{{λ}_{l}} , 0 ]}^{T}$ |
| | | $\frac{\partial {r}_{VIS}^{non} ( {x}_{i}^{R} , {x}_{j}^{R} , {f}_{l} )}{\partial {λ}_{l}} = \\ \frac{\partial f ( {p}_{l 3 D}^{{c}_{j}} )}{\partial {p}_{l 3 D}^{{c}_{j}}} {R}_{cb} {R}_{{wb}_{j}}^{T} {R}_{{wb}_{i}} {{R}_{bc} [ - \frac{{u}_{il}}{{λ}_{l}^{2}} , - \frac{{v}_{il}}{{λ}_{l}^{2}} , - \frac{1}{{λ}_{l}^{2}} ]}^{T}$ |
| Jacobian (Anchor Feature) | $\frac{\partial {r}_{DP} ( {λ}_{l} )}{\partial {λ}_{l}} = {[ 0 , 0 , 1 ]}^{T}$ | $\frac{\partial {r}_{VIS}^{anchor} ( {u}_{il} , {v}_{il} , {λ}_{l} )}{\partial {u}_{il}} = {[ 1 , 0 , 0 ]}^{T}$ |
| | | $\frac{\partial {r}_{VIS}^{anchor} ( {u}_{il} , {v}_{il} , {λ}_{l} )}{\partial {v}_{il}} = {[ 0 , 1 , 0 ]}^{T}$ |
| | | $\frac{\partial {r}_{VIS}^{anchor} ( {u}_{il} , {v}_{il} , {λ}_{l} )}{\partial {λ}_{l}} = {[ 0 , 0 , 1 ]}^{T}$ |

TABLE 3
MSL-DVIO Residue and Jacobian with Time Offset

| | ID Feature Parameter | 3D Feature Parameter |
|---|---|---|
| Image Residue (Non- | $g ( {T}_{cb} {T}_{{b}_{j} w} {T}_{{wb}_{i}} {{T}_{bc} [ \frac{\overline{{u}_{ilTD}}}{{λ}_{l}} , \frac{\overline{{v}_{ilTD}}}{{λ}_{l}} , \frac{1}{{λ}_{l}} , 1 ]}^{T} ) - {Z}_{ljTD}^{IMG}$ | $g ( {T}_{cb} {T}_{{b}_{j} w} {T}_{{wb}_{i}} {{T}_{bc} [ \frac{{u}_{ilTD}}{{λ}_{l}} , \frac{{v}_{ilTD}}{{λ}_{l}} , \frac{1}{{λ}_{l}} , 1 ]}^{T} ) - {Z}_{l 3 DjTD}^{IMG}$ |
| Anchor) | | |
| Depth Residue (Non- | ${( {\vert {T}_{cb} {T}_{{b}_{j} w} {T}_{{wb}_{i}} {{T}_{bc} [ \frac{\overline{{u}_{ilTD}}}{{λ}_{l}} , \frac{\overline{{v}_{ilTD}}}{{λ}_{l}} , \frac{1}{{λ}_{l}} , 1 ]}^{T} \vert}_{z} )}^{- 1} - \frac{1}{{z}_{ljTD}^{IMG}}$ | ${( {\vert {T}_{cb} {T}_{{b}_{j} w} {T}_{{wb}_{i}} {{T}_{bc} [ \frac{{u}_{ilTD}}{{λ}_{l}} , \frac{{v}_{ilTD}}{{λ}_{l}} , \frac{1}{{λ}_{l}} , 1 ]}^{T} \vert}_{z} )}^{- 1} - \frac{1}{{z}_{l 3 DjTD}^{IMG}}$ |
| Anchor) | | |
| Image | N/A | [uᵢₗ, vᵢₗ]^{T} − Z_{l3DiTD}^{IMG} |
| Residue | | |
| (Anchor) | | |
| Depth Residue (Anchor) | ${( {\vert {[ \frac{\overline{{u}_{ilTD}}}{{λ}_{l}} , \frac{\overline{{v}_{ilTD}}}{{λ}_{l}} , \frac{1}{{λ}_{l}} , 1 ]}^{T} \vert}_{z} )}^{- 1} - \frac{1}{{z}_{ljTD}^{IMG}}$ | λₗ − Z_{l3DiTD}^{DP} |
| Jacobian (Anchor Pose) | $\frac{\partial {r}_{VIS}^{TD} ( {x}_{i}^{R} , {x}_{j}^{R} , {λ}_{l} )}{\partial {p}_{{b}_{i}}^{w}} = \frac{\partial f ( {p}_{lTD}^{{c}_{j}} )}{\partial {p}_{lTD}^{{c}_{j}}} {R}_{cb} {R}_{{wb}_{j}}^{T}$ | $\frac{\partial {r}_{VIS}^{TD} ( {x}_{i}^{R} , {x}_{j}^{R} , {f}_{l} )}{\partial {p}_{{b}_{i}}^{w}} = \frac{\partial f ( {p}_{l 3 DTD}^{{c}_{j}} )}{\partial {p}_{l 3 DTD}^{{c}_{j}}} {R}_{cb} {R}_{{wb}_{j}}^{T}$ |
| Jacobian (Anchor Rotation) | $\frac{\partial {r}_{VIS}^{TD} ( {x}_{i}^{R} , {x}_{j}^{R} , {λ}_{l} )}{\partial {θ}_{i}} = - \frac{\partial f ( {p}_{lTD}^{{c}_{j}} )}{\partial {p}_{lTD}^{{c}_{j}}} {R}_{cb} {R}_{{wb}_{j}}^{T} {{R}_{{wb}_{i}} [ {p}_{lTD}^{{b}_{i}} ]}_{\times }$ | $\frac{\partial {r}_{VIS}^{TD} ( {x}_{i}^{R} , {x}_{j}^{R} , {f}_{l} )}{\partial {θ}_{i}} = - \frac{\partial f ( {p}_{l 3 DTD}^{{c}_{j}} )}{\partial {p}_{l3 DTD}^{{c}_{j}}} {R}_{cb} {R}_{{wb}_{j}}^{T} {{R}_{{wb}_{i}} [ {p}_{l 3 D}^{{b}_{i}} ]}_{\times }$ |
| Jacobian (Non Anchor | $\frac{\partial {r}_{VIS}^{TD} ( {x}_{i}^{R} , {x}_{j}^{R} , {λ}_{l} )}{\partial {p}_{{b}_{j}}^{w}} = \frac{\partial f ( {p}_{lTD}^{{c}_{j}} )}{\partial {p}_{lTD}^{{c}_{j}}} {R}_{cb} {R}_{{wb}_{j}}^{T}$ | $\frac{\partial {r}_{VIS}^{TD} ( {x}_{i}^{R} , {x}_{j}^{R} , {f}_{l} )}{\partial {p}_{{b}_{j}}^{w}} = - \frac{\partial f ( {p}_{l 3 DTD}^{{c}_{j}} )}{\partial {p}_{l 3 DTD}^{{c}_{j}}} {R}_{cb} {R}_{{wb}_{j}}^{T}$ |
| Pose) | | |
| Jacobian (Non Anchor | $\frac{\partial {r}_{VIS}^{TD} ( {x}_{i}^{R} , {x}_{j}^{R} , {λ}_{l} )}{\partial {θ}_{j}} = \frac{\partial f ( {p}_{l}^{{c}_{j}} )}{\partial {p}_{l}^{{c}_{j}}} {{R}_{cb} [ {p}_{lTD}^{{b}_{j}} ]}_{\times }$ | $\frac{\partial {r}_{VIS}^{TD} ( {x}_{i}^{R} , {x}_{j}^{R} , {f}_{l} )}{\partial {θ}_{j}} = \frac{\partial f ( {p}_{l 3 DTD}^{{c}_{j}} )}{\partial {p}_{l 3 DTD}^{{c}_{j}}} {{R}_{cb} [ {p}_{l 3 D}^{{b}_{j}} ]}_{\times }$ |
| Rotation) | | |
| Jacobian (Non anchor Feature) | $\frac{\partial {r}_{VIS}^{TD} ( {x}_{i}^{R} , {x}_{j}^{R} , {λ}_{l} )}{\partial {λ}_{l}} = \frac{\partial f ( {p}_{l}^{{c}_{j}} )}{\partial {p}_{l}^{{c}_{j}}} {R}_{cb} {R}_{{wb}_{j}}^{T} {R}_{{wb}_{i}} {{R}_{bc} [ - \frac{\overline{{u}_{ilTD}}}{{λ}_{l}^{2}} , - \frac{\overline{{v}_{ilTD}}}{{λ}_{l}^{2}} , - \frac{1}{{λ}_{l}^{2}} ]}^{T}$ | $\frac{\partial {r}_{VIS}^{TD} ( {x}_{i}^{R} , {x}_{j}^{R} , {f}_{l} )}{\partial {u}_{il}} = \frac{\partial f ( {p}_{l3 DTD}^{{c}_{j}} )}{\partial {p}_{l 3 DTD}^{{c}_{j}}} {R}_{cb} {R}_{{wb}_{j}}^{T} {R}_{{wb}_{i}} {{R}_{bc} [ \frac{1}{{λ}_{l}} , 0 , 0 ]}^{T}$ |
| | | $\frac{\partial {r}_{VIS}^{TD} ( {x}_{i}^{R} , {x}_{j}^{R} , {f}_{l} )}{\partial {v}_{il}} = \frac{\partial f ( {p}_{l 3 DTD}^{{c}_{j}} )}{\partial {p}_{l 3 DTD}^{{c}_{j}}} {R}_{cb} {R}_{{wb}_{j}}^{T} {R}_{{wb}_{i}} {{R}_{bc} [ 0 , \frac{1}{{λ}_{l}} , 0 ]}^{T}$ |
| | | $\frac{\partial {r}_{VIS}^{TD} ( {x}_{i}^{R} , {x}_{j}^{R} , {f}_{l} )}{\partial {λ}_{l}} = \frac{\partial f ( {p}_{l3 DTD}^{{c}_{j}} )}{\partial {p}_{l 3 DTD}^{{c}_{j}}} {R}_{cb} {R}_{{wb}_{j}}^{T} {R}_{{wb}_{i}} {{R}_{bc} [ - \frac{{u}_{ilTD}}{{λ}_{l}^{2}} , - \frac{{v}_{ilTD}}{{λ}_{l}^{2}} , - \frac{1}{{λ}_{l}^{2}} ]}^{T}$ |
| Jacobian (Anchor Feature) | $\frac{\partial {r}_{DP} ( {λ}_{l} )}{\partial {λ}_{l}} = {[ 0 , 0 , 1 ]}^{T}$ | $\frac{\partial {r}_{VIS}^{TDanchor} ( {u}_{il} , {v}_{il} , {f}_{l} )}{\partial {u}_{il}} = {[ 1 , 0 , 0 ]}^{T}$ |
| | | $\frac{\partial {r}_{VIS}^{TDanchor} ( {u}_{il} , {v}_{il} , {f}_{l} )}{\partial {v}_{il}} = {[ 0 , 1 , 0 ]}^{T}$ |
| | | $\frac{\partial {r}_{VIS}^{TDanchor} ( {u}_{il} , {v}_{il} , {f}_{l} )}{\partial {λ}_{l}} = {[ 0 , 0 , 1 ]}^{T}$ |
| Jacobian (Time Offset) | $\frac{\partial {r}_{VIS}^{TD} ( {x}_{i}^{R} , {x}_{j}^{R} , {λ}_{l} )}{\partial △ t} = \frac{\partial f ( {p}_{lTD}^{{c}_{j}} )}{\partial {p}_{lTD}^{{c}_{j}}} \frac{- 1}{{λ}_{l}} {R}_{cb} {R}_{{wb}_{j}}^{T} {R}_{{wb}_{i}} {R}_{bc} [ \begin{matrix}{V}_{li}^{IMG} \\ 0\end{matrix} ] + [ \begin{matrix}{V}_{lj}^{IMG} \\ 0\end{matrix} ]$ | $\frac{\partial {r}_{VIS}^{non} ( {x}_{i}^{R} , {x}_{j}^{R} , {f}_{l} )}{\partial △ t} = \frac{\partial f ( {p}_{l 3 DTD}^{{c}_{j}} )}{\partial {p}_{l3 DTD}^{{c}_{j}}} \frac{- 1}{{λ}_{l}} {R}_{cb} {R}_{{wb}_{j}}^{T} {R}_{{wb}_{i}} {R}_{bc} [ \begin{matrix}{V}_{li}^{IMG} \\ 0\end{matrix} ] + [ \begin{matrix}{V}_{lj}^{IMG} \\ 0\end{matrix} ]$ |

The changes to the graph optimization in MSL-DVIO are described above. Embodiments are provided related to 1D and 3D feature parameterization. To estimate the initial value for the feature parameter, the estimation process is divided into in two separate blocks. A first block estimates the inverse depth estimation for the feature, and a second block estimates the initial value of the 2D feature measurement in the anchor frame.

Feature depth is computed with respect to the anchor frame. In MSL-DVIO, the initial estimate of feature depth is computed using the sliding window measurement and using the feature depth measurement from the depth map.

In the first step for estimating the initial depth estimate, the depth measurement for feature point from the depth map is used to compute the feature depth. Kₗ={k₁, k₂, . . . , kₙ} is the 3D feature measurement for a single landmark l in the full sliding window. Here, k₁=(u̅₁̅ₗ̅, v̅₁̅ₗ̅, z₁ₗ^{DP}) corresponds to the feature measurement of landmark l in the anchor frame, and k₂, . . . , kₙ corresponds to the feature measurement of landmark l in the non-anchor frame. X^{R}={x₁^{R}, . . . , xₙ^{R}} is the robot pose for the sliding window for which the graph optimization is run. Using the sliding window pose and feature measurement for the landmark l, a 3D point is projected to the anchor frame, as set forth in Equation (75) below.

$$= [ \begin{matrix} \\ \\ \end{matrix} ] = {T}_{cb} {T}_{{b}_{1} w} {T}_{{wb}_{j}} {T}_{bc} [ \begin{matrix}\overline{{u}_{jl}} {z}_{jl}^{DP} \\ \overline{{v}_{jl}} {z}_{jl}^{DP} \\ {z}_{jl}^{DP}\end{matrix} ] for all the j frame in the sliding window . \qquad ( 75 )$$

An anchor frame 3D feature measurement estimate is generated as

$$= ( , , ) = ( \frac{{A}_{1}}{{A}_{3}} , \frac{{A}_{2}}{{A}_{3}} , {A}_{3} ) .$$

Using the 2D estimate ( [symbol] , [symbol] ), a reprojection error of the feature on the anchor frame is generated. A threshold is applied on this reprojection error to classify them as inliers and outliers. The feature depth is initialized using the average of all the inlier estimated anchor frame depths.

To estimate the depth and feature 2D location estimate in the anchor frame using only the sliding window data and feature 2D location, a direct linear transform (DLT) algorithm is used. The problem is formulated in the form AX=0 and solved using singular value decomposition. For example, the landmark l=(xₗ^{anch}, yₗ^{anch}, zₗ^{anch}) may be a 3D point observed in the camera anchor frame for the sliding window X^{R}={x₁^{R}, . . . , xₙ^{R}} and may have feature measurement as Kₗ={k₁, k₂, . . . , kₙ}. x₁^{R} is the anchor frame and k₁ is the feature measurement in anchor frame. Using the camera projection matrix, the relationship of Equation (76) is provided.

$$[ \begin{matrix}\overline{{u}_{Jl}} \\ \overline{{v}_{Jl}} \\ 1\end{matrix} ] = α T ( {x}_{j}^{R} ) [ \begin{matrix}{x}_{l}^{a n c h} \\ {y}_{l}^{a n c h} \\ {z}_{l}^{a n c h} \\ 1\end{matrix} ] \qquad ( 76 )$$

where j is every keyframe in the sliding window, T(xⱼ^{R}) is a relative transformation matrix between keyframe and anchor frame, using the rotation vector and translation vector in xⱼ^{R} and x₁^{R}, and α is the scale factor.

The cross product of two vectors in the same direction is zero, and from the relation

Equation (77) is provided.

$$[ \begin{matrix}\overline{{u}_{Jl}} \\ \overline{{v}_{Jl}} \\ 1\end{matrix} ] \times T ( {x}_{j}^{R} ) [ \begin{matrix}{x}_{l}^{w} \\ {y}_{l}^{w} \\ {z}_{l}^{w} \\ 1\end{matrix} ] = [ \begin{matrix}0 \\ 0 \\ 0\end{matrix} ] \qquad ( 77 )$$

In Equation (77), T(xⱼ^{R}) is derived to its expanded form of 3×4 matrix and the notation is minimized, as set forth in Equation (78) below.

$$T ( {x}_{j}^{R} ) [ \begin{matrix}{x}_{l}^{w} \\ {y}_{l}^{w} \\ {z}_{l}^{w} \\ 1\end{matrix} ] = [ \begin{matrix}{t}_{1} & {t}_{2} & {t}_{3} & {t}_{4} \\ {t}_{5} & {t}_{6} & {t}_{7} & {t}_{8} \\ {t}_{9} & {t}_{10} & {t}_{11} & {t}_{12}\end{matrix} ] [ \begin{matrix}{x}_{l}^{w} \\ {y}_{l}^{w} \\ {z}_{l}^{w} \\ 1\end{matrix} ] = [ \begin{matrix}{T}_{1}^{T} L \\ {T}_{2}^{T} L \\ {T}_{3}^{T} L\end{matrix} ] \qquad ( 78 )$$

Where, T₁^{T}=[t₁ t₂ t₃ t₄], T₁^{T}=[t₅ t₆ t₇ t₈] and

$${T}_{1}^{T} = [ {t}_{9} {t}_{10} {t}_{11} {t}_{12} ] , and L = [ \begin{matrix}{x}_{l}^{w} \\ {y}_{l}^{w} \\ {z}_{l}^{w} \\ 1\end{matrix} ] .$$

The cross product term is set forth in Equation (79) below.

$$[ \begin{matrix}\overline{{u}_{jl}} \\ \overline{{v}_{jl}} \\ 1\end{matrix} ] \times [ \begin{matrix}{T}_{1}^{T} L \\ {T}_{2}^{T} L \\ {T}_{3}^{T} L\end{matrix} ] = [ \begin{matrix}{v}_{jl} {T}_{3}^{T} L - {T}_{2}^{T} L \\ {T}_{1}^{T} L - {u}_{jl} {T}_{3}^{T} L \\ {u}_{jl} {T}_{2}^{T} L - {v}_{j l} {T}_{1}^{T} L\end{matrix} ] = [ \begin{matrix}0 \\ 0 \\ 0\end{matrix} ] \qquad ( 79 )$$

Equation (79) can be further reduced, as the third line is the linear combination of the first and second line, resulting in Equation (80) for a single observation as set forth below.

$$[ \begin{matrix}\overline{{v}_{jl}} {T}_{3}^{T} L - {T}_{2}^{T} L \\ {T}_{1}^{T} L - \overline{{u}_{jl}} {T}_{3}^{T} L\end{matrix} ] = [ \begin{matrix}\overline{{v}_{jl}} {T}_{3}^{T} - {T}_{2}^{T} \\ {T}_{l}^{T} - \overline{{u}_{jl}} {T}_{3}^{T}\end{matrix} ] L = [ \begin{matrix}0 \\ 0\end{matrix} ] \qquad ( 80 )$$

Equation (80) can be written as Equation (81) below.

AⱼL=0 (81)

Observations for each feature are stacked, and a system of linear equations is created that will have the form AL=0. To solve this homogenous linear system, minimizing the algebraic least-squares error is solved using singular value decomposition, where the solution will be the eigenvector corresponding to the smallest eigenvalue of A^{T}A, as set forth in Equations (82) and (83) below.

$$U Σ V = SVD ( A ) \qquad ( 82 )$$

$$\hat{L} = [ \begin{matrix} \\ \\ \\ \end{matrix} ] = [ \begin{matrix}{V}_{1 , 4} \\ {V}_{2 , 4} \\ {V}_{3 , 4} \\ {V}_{4 , 4}\end{matrix} ] \qquad ( 83 )$$

The estimate of the 2D measurement and the depth of the landmark in the anchor frame are generated, as set forth in Equation (84) below.

$$= \frac{/}{} , = \frac{/}{} , = \frac{}{} \qquad ( 84 )$$

These estimates are then used to initialize the state variables in the graph optimization problem. In the above-described methods, the initial value of the feature parameters depends on the feature measurement and the sliding window poses. In the case of depth estimation, all of the depth is initialized with the average value of the inlier depth measurement and only features that are not estimated using the first step are initialized using the second method. In the case of 2D feature parameter initialization, there is only the second method for initialization.

When there are large errors in sliding window poses, the above-described method is susceptible to bad initialization. Since the estimation depends on the quality of the sliding window poses, this issue is more pronounced in the first optimization run as part of the initialization step. To avoid bad behavior of the MSL-DVIO system, fixes are added to the optimization steps, which are only for the first time optimization run as part of the initialization steps.

To perform depth-aiding, the depth map frame is utilized. These depth map frames are generated using a depth sensing module. There are two types of depth sensing modules. A first type is a passive depth sensor, and a second type is an active depth sensor. An example of a passive depth sensor includes a depth from a stereo camera pair, and an example of active depth sensor includes a TOF camera or structure light camera.

All sensors estimate the scene depth based upon measurement models. Since embodiments focus on RGBD sensors, active sensors are focused on herein.

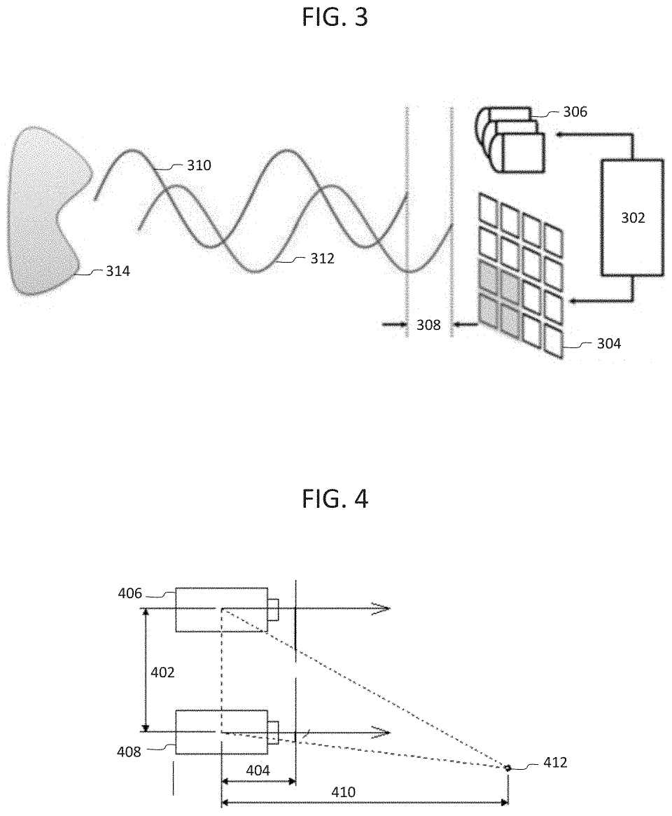

FIG. 3 is a diagram illustrating a TOF camera, according to an embodiment. The TOF camera includes a controller 302, a sensor 304, and an infra-red (IR) emitter 306. A phase difference 308 between a transmitted signal 310 and a received signal 312 from an object 314 is used to estimate a depth.

FIG. 4 is a diagram illustrating structured light sensors, according to an embodiment. A dot pattern using a baseline 402 and a focus length 404 is used to compute a disparity measurement between a projector 406 and a camera 408, which is then used to estimate a depth 410 of a point 412.

As described above in two simplistic examples of the measurement models, the depth measurement from a sensor is very specific to the type of the sensor used. To use this depth measurement along with the 2D feature measurement for performing a graph optimization, a per sensor-based model is needed for the measurement noise.

While performing depth-aiding in the MSL-DVIO, an additive Gaussian model is assumed to be used for the measurement noise for the inverse depth measurement. This type of model may not be accurate for different types of sensors. For example, a sensor having an active IR stereo sensor may be used. This sensor uses both IR and visible light to perform dense stereo matching based on features it can see. Since the sensor is using disparity as a measurement for estimating the depth of a feature point, using additive Gaussian noise for the inverse depth is an acceptable model for depth uncertainty.

In the graph optimization problem, to maintain a fixed size for the optimization problem, a sliding window is used for performing the graph optimization. With this approach a fixed size and a smaller processing time are maintained in the non-linear optimization step. Once a sliding window is full with a max number of nodes allowed to maintain the fixed size of the problem, marginalization is performed, in which a certain subset of nodes Xₘ are dropped and a graph with the remaining nodes Xᵣ(Xₘ∪Xᵣ=X, Xₘ∩Xᵣ=∅) is formed.

The cost function that is minimized in the batch optimization is of the form shown in Equation (85) below.

C(X)= [symbol] (X)Ω [symbol] (X) (85)

Here, [symbol] (X) is a column vector of length L containing all the constraints among X, and Ω is a L×L diagonal matrix as the combining weight for each constraint.

After marginalization, the batch optimization is only over the remaining variables Xᵣ. The revised cost function is denoted as F(Xᵣ). The purpose of marginalization is to identify such a revised cost function F(Xᵣ) that provides the same optimal choice of Xᵣ as C(X).

This puts the following requirement on F(Xᵣ): find F(Xᵣ) such that Equation (86) below.

$$F ( {X}_{r} ) = {min}_{{X}_{m} \vert {X}_{r}} C ( [ \begin{matrix}{X}_{m} \\ {X}_{r}\end{matrix} ] ) \qquad ( 86 )$$

The process of marginalization can then be summarized in following steps.

Given information matrix H and error vector [symbol] , as shown in equation (87) below:

$$H = [ \begin{matrix}{H}_{m m} & {H}_{m r} \\ {H}_{r m} & {H}_{r r}\end{matrix} ] , \vec{b} = [ \begin{matrix}{\vec{b}}_{m} \\ {\vec{b}}_{r}\end{matrix} ] \qquad ( 87 )$$

The marginalization process will compute the new information matrix and error vector as shown in Equation (88) below.

H_{new}=Hᵣᵣ−HᵣₘHₘₘ⁻¹Hₘᵣ

[symbol]

= [symbol] −HᵣₘHₘₘ⁻¹ [symbol] (88)

In order to perform the marginalization process, the invert of the information matrix related to the marginalized state Hₘₘ is needed. Depending upon how large the marginalized state is, this can become a very time consuming. In systems such as VINS-Mono, an Eigen decomposition of the complete matrix is performed to compute the inverse of the matrix, which can become a very time consuming process and will impact the real time performance of the final algorithm.

Accordingly, two changes are made to optimize the marginalization process for MSL-DVIO 1D. First, the problem is divided into two blocks: 1) marginalization of all the landmarks; and 2) marginalization of the keyframe pose, speed, and bias terms. The marginalization of all the landmarks is easy since a diagonal matrix is provided from 1D feature parameterization. The marginalization problem can be rewritten as Equation (89) below, given information matrix H and error vector [symbol] .

$$H = [ \begin{matrix}{H}_{m m} & {H}_{m r} \\ {H}_{r m} & {H}_{r r}\end{matrix} ] = [ \begin{matrix}{H}_{m m 11} & {H}_{m m 12} & {H}_{m r 1} \\ {H}_{m m 21} & {H}_{m m 22} & {H}_{m r 2} \\ {H}_{r m 1} & {H}_{r m 2} & {H}_{r r}\end{matrix} ] , \qquad ( 89 )$$

$$\vec{b} = [ \begin{matrix}{\vec{b}}_{m} \\ {\vec{b}}_{r}\end{matrix} ] = [ \begin{matrix}{\vec{b}}_{m 1} \\ {\vec{b}}_{m 2} \\ {\vec{b}}_{r}\end{matrix} ]$$

Hₘₘ₁₁ is the information matrix for landmarks, which is a simple diagonal matrix Hₘₘ₁₁=diag( [symbol] ₘₘ₁₁).

In the second step, keyframe pose, speed, and bias terms are marginalized, as shown in Table 4 below.

TABLE 4
Block Marginalization For MSL-DVIO 1D

Step 1): Marginalize landmarks
$H = [ \begin{matrix}{H}_{m m} & {H}_{mr} \\ {H}_{rm} & {H}_{rr}\end{matrix} ] = [ \begin{matrix}{H}_{m m 11} & {H}_{m m 12} & {H}_{mr 1} \\ {H}_{m m 21} & {H}_{m m 22} & {H}_{mr 2} \\ {H}_{rm 1} & {H}_{rm 2} & {H}_{rr}\end{matrix} ] , \vec{b} = [ \begin{matrix}{\vec{b}}_{m} \\ {\vec{b}}_{r}\end{matrix} ] = [ \begin{matrix}{\vec{b}}_{m 1} \\ {\vec{b}}_{m 2} \\ {\vec{b}}_{r}\end{matrix} ]$
${H}_{m m 11}^{- 1} = diag ( \frac{1}{{\vec{h}}_{m m 11}} )$
${H}_{new - temp} = [ \begin{matrix}{H}_{m m 22} & {H}_{mr 2} \\ {H}_{rm 2} & {H}_{rr}\end{matrix} ] - [ \begin{matrix}{H}_{m m 21} \\ {H}_{rm 1}\end{matrix} ] {H}_{m m 11}^{- 1} [ \begin{matrix}{H}_{m m 12} & {H}_{mr 1}\end{matrix} ] = [ \begin{matrix}{H}_{11} & {H}_{12} \\ {H}_{21} & {H}_{22}\end{matrix} ]$
${\vec{b}}_{new - temp} = [ \begin{matrix}{\vec{b}}_{m 2} \\ {\vec{b}}_{r}\end{matrix} ] - [ \begin{matrix}{H}_{m m 21} \\ {H}_{rm 1}\end{matrix} ] {H}_{m m 11}^{- 1} {\vec{b}}_{m 1} = [ \begin{matrix}{\vec{b}}_{1} \\ {\vec{b}}_{2}\end{matrix} ]$
Step 2): Marginalize other terms
H_{new} = H₂₂ − H₂₁H₁₁⁻¹H₁₂ [symbol]
_{new} = [symbol] ₂ − H₂₁H₁₁⁻¹ [symbol] ₁

To perform the marginalization of the keyframe pose, speed, and bias terms, the Safety Cholesky algorithm is used. This provides more robust and faster processing for the second step of the block marginalization in MSL-DVIO 1D. The summary of this algorithm is set forth below in Table 5.

TABLE 5
Safety Cholesky Decomposition

```
H is an N × N symmetric real positive definity matrix.
Initialize L to be an N × N zero matrix.
For j = 1:N
${d}_{j} = {H}_{j , j} - {\sum }_{k = 1}^{j - 1} {L}_{j , k}^{2}$
    if dⱼ > ϵ²
${L}_{j , j} = \sqrt{{d}_{j}}$
      For i = j + 1:N
${L}_{i , j} = \frac{1}{{L}_{j , j}} ( {H}_{i , j} - {\sum }_{k = 1}^{j - 1} {L}_{i , k} {L}_{j , k} )$
  Else if dⱼ > −ϵ²
L_{j,j} = ϵ, L_{i,j} = 0
Else return FALSE; //Cholesky decomposition fails
```

In case of MSL-DVIO 3D, a single simple step cannot be performed to compute the inverse of the block for the landmark, since each landmark is correlated to 3 states in the graph. Thus, the inverse of 3×3 matrix is handled one by one for each landmark. Hence, the block-by-block marginalization process for the MSL-DVIO 3D changes to the process shown in Table 6 below.

TABLE 6
Block Marginalization for MSL-DVIO 3D

n landmark to be marginalized.
H_{3×3} and [symbol] _{3×3} denotes the information matrix and residue for the first
landmark, providing the following matrices:
$H = [ \begin{matrix}{H}_{m m} & {H}_{mr} \\ {H}_{rm} & {H}_{rr}\end{matrix} ] = [ \begin{matrix}{H}_{3 ⨯ 3} & {H}_{m m 12} & {H}_{mr 1} \\ {H}_{m m 21} & {H}_{m m 22} & {H}_{mr 2} \\ {H}_{rm 1} & {H}_{rm 2} & {H}_{rr}\end{matrix} ] , \vec{b} = [ \begin{matrix}{\vec{b}}_{m} \\ {\vec{b}}_{r}\end{matrix} ] = [ \begin{matrix}{\vec{b}}_{3 ⨯ 3} \\ {\vec{b}}_{m 2} \\ {\vec{b}}_{r}\end{matrix} ]$
${H}_{new - temp} = [ \begin{matrix}{H}_{m m 22} & {H}_{mr 2} \\ {H}_{rm 2} & {H}_{rr}\end{matrix} ] - [ \begin{matrix}{H}_{m m 21} \\ {H}_{rm 1}\end{matrix} ] {H}_{3 ⨯ 3}^{- 1} [ \begin{matrix}{H}_{m m 12} & {H}_{mr 1}\end{matrix} ] = [ \begin{matrix}{H}_{11} & {H}_{12} \\ {H}_{21} & {H}_{22}\end{matrix} ]$
${\vec{b}}_{new - temp} = [ \begin{matrix}{\vec{b}}_{m 2} \\ {\vec{b}}_{r}\end{matrix} ] - [ \begin{matrix}{H}_{m m 21} \\ {H}_{rm 1}\end{matrix} ] {H}_{3 ⨯ 3}^{- 1} {\vec{b}}_{3 ⨯ 3} = [ \begin{matrix}{\vec{b}}_{1} \\ {\vec{b}}_{2}\end{matrix} ]$
Step 2): Marginalize other terms
H_{new} = H₂₂ − H₂₁H₁₁⁻¹H₁₂ [symbol]
_{new} = [symbol] ₂ − H₂₁H₁₁⁻¹ [symbol] ₁

As described above, each landmark is separately marginalized for the MSL-DVIO 3D. With this approach, a large improvement in processing time is achieved since the size of the matrix inversion is small, which is much faster compared to trying to invert one large matrix in a single step.

The platform design of the VINS-Mono system may be used for the above-described system design. VINS-Mono has current state of the art VIO implementation using a graph optimization approach. Depth-aiding may be added on top of the current system to avoid the rework needed in implementing a complete VIO system.

Depth-aiding is added to the vision part of the VINS-Mono by incorporating the following changes.

Depth data input/output (I/O) requires the reading of the depth measurement and processing these measurement synchronized with the 2D feature measurement.

Depth measurement requires the computing of the depth measurement associated with every 2D feature measurement and the adding of that measurement to the current processing pipeline.

Optimization computes the depth residue based on the depth measurement and state parameters. This residue is added as a parameter block in the graph optimization problem.

The depth data I/O, the depth measurement, and the depth residue and optimization are performed separately for depth-aiding for the anchor keyframe, depth-aiding for the non-anchor keyframe, depth-aiding for unsynchronized sensors, and depth-aiding for 3D feature parametrization.

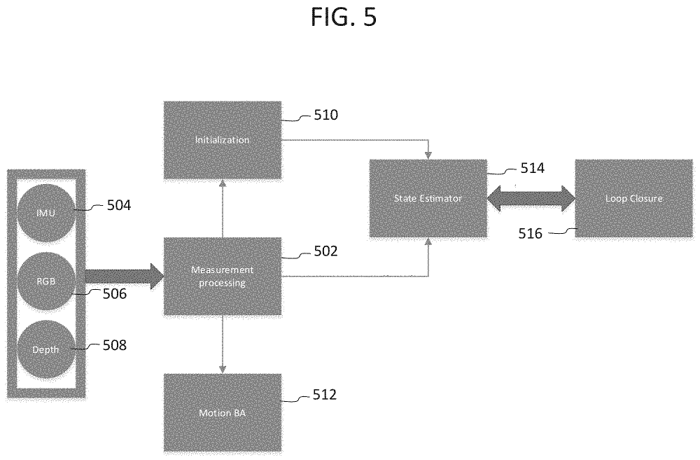

FIG. 5 is a diagram illustrating a system flow of the MSL-DVIO, according to an embodiment.

In a measurement processing block 502, input data is taken from an IMU 504, an RGB camera 506, and a depth sensor 508, and then processed separately. The RGB camera 506 and the depth sensor 508 may be combined as an RGBD sensor. For the IMU data stream from the IMG 504, IMU pre-integration is performed at the measurement processing block 502. For the RGB camera frame from the RGB camera 506, feature detection and tracking are performed at the measurement processing block 502. For the depth map from the depth sensor 508, the depth is generated for the feature measured in the RGB camera frame at the measurement processing block 502.

In an initialization block 510, an IMU pre-integrate term and a 2D feature track are received from the measurement processing block 502, and a visual-only structure from motion is performed. Visual inertial alignment is also performed to create an initial keyframe for a sliding window map.

In a motion BA block 512, a 2D feature track and the IMU pre-integrate term are received from the measurement processing block 502 to perform frame-to-frame pose tracking.

In a state estimator block 514, the initial keyframe is received from the initialization block 510 and the IMU pre-integrate term, the 2D feature track, and the depth measurement are received from the measurement processing block 502. Optimization of the factor graph is performed and a sliding graph is created based on FIG. 2, at the state estimator block 514. Once the graph is created, the system is optimized using a nonlinear solver.

In loop closure block 516, the pose graph from the state estimator 514 is used in an attempt to minimize long term errors from the state estimator block 514.

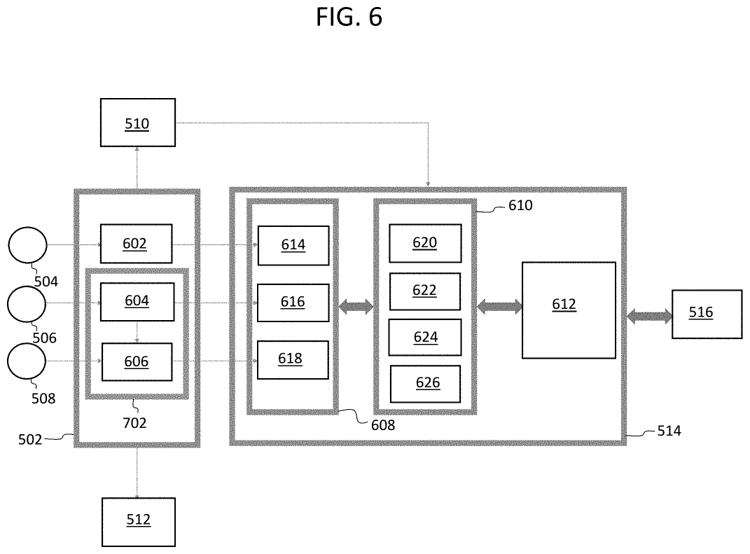

FIG. 6 is a diagram illustrating a detailed system flow of the MSL-DVIO, according to an embodiment of the disclosure.

The measurement processing block 502 includes an IMU pre-integration block 602, a feature detection and tracking block 604, and a depth measurement block 606.

The state estimator block 514 includes a key frame residue block 608, a sliding window graph block 610, nd a graph optimization block 612. The key frame residue block 608 includes an IMU residue block 614, a 2D feature residue block 616, and a depth residue block 618. The sliding window graph block 610 includes an IMU parameter block 620, an anchor frame parameter block 622, a non-anchor frame parameter block 624, and a time offset parameter block 626.

The IMU residue is the loss between the estimated value of 6DOF pose for keyframes, velocity, and biases for the IMU, and the IMU measurement (e.g., accelerometer and gyroscope measurement). The image residue is the loss between the estimated value of the 6DOF pose for keyframes and the location of a landmark (1D or 3D), and the 2D measurement of the landmark on the keyframe. The depth residue is the loss between the estimated value of 6DOF pose for keyframes and the location of a landmark (1D or 3D), and the depth measurement of the landmark on the depth map.

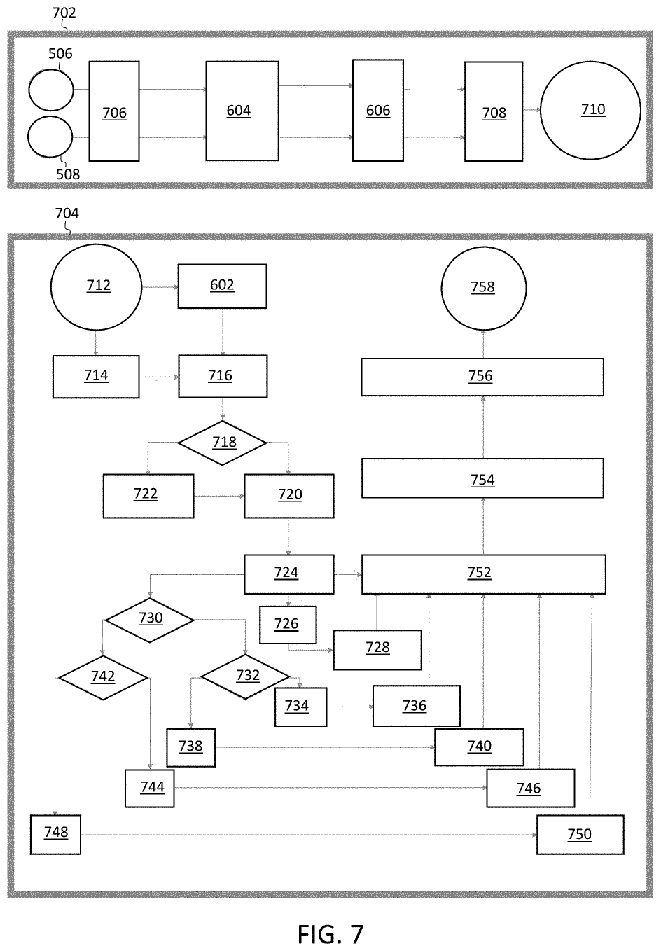

FIG. 7 is a diagram illustrating MSL-DVIO 1D feature implementation, according to an embodiment. In MSL-DVIO, the implementation of the depth-aiding changes are spread on two threads. A first thread is a feature tracker thread 702 and a second thread is in a state estimator thread 704.

The feature tracker thread 702 includes depth and image measurement processing. The RGBD data from the RGB camera 506 and the depth sensor 508 are synchronized at a robot operating system (ROS) synchronizer block 706. The ROS synchronizer block 706 provides an RGB image message and a depth image message to the feature detection and tracking block 604. The feature detection and tracking block 604 provides a feature measurement and a depth image message to the depth measurement block 606. The depth measurement block provides the feature measurement and the depth measurement to a velocity computation block 708, which computes feature velocity in the image and depth domains. Velocity, feature, and depth measurements are then published on the ROS platform at 710.

The state estimator thread 704 handles the majority of work for graph optimization. IMU and feature data are received at 712. The IMU data is provided to the IMU pre-integration block 602 to create the IMU pre-integrate term for optimization. The feature data is provided to a keyframe selection block 714 to create keyframes that can be added to the sliding window. A sliding window setup block 716 receives the IMU pre-integrate term and the keyframes. At block 718, it is determined whether initialization is complete based on the sliding window data from the sliding window setup block 716. The sliding window data is provided to a triangulate feature block 720, if initialization is complete. If initialization is not complete, the sliding window data is first provided to an initial structure block 722. The sliding window data is then provided to a pose graph set-up block 724, which sets up a pose graph by initializing the depth of the feature in the sliding window.

Using the pose graph, IMU residue is determined at block 726, and an IMU factor for pose graph optimization is determined at block 728. Using the pose graph, it is determined whether a time delta estimation is known at block 730. If a time delta estimation is not known, it is determined whether a frame is the anchor frame at block 732. If it is the anchor frame, anchor frame depth residue is determined at 734, and an anchor frame vision factor for pose graph optimization is determined at block 736. If it is not the anchor frame, non-anchor frame image and depth residue is determined at block 738, and a non-anchor frame vision factor for pose graph optimization is determined at block 740.

Generally, a vision factor is generated using vision sensors, which include the 6DOF pose of the keyframes, the location of the landmark, the depth residue, and the image residue. An IMU factor is generated using the IMU sensors, which include the 6DOF pose of the keyframes, velocity and biases of the IMU, and the IMU residue.

If the time delta estimation is known, it is determined whether a frame is the anchor frame at block 742. If it is the anchor frame, anchor frame time delta depth residue is determined at block 744, and an anchor frame time delta vision factor for pose graph optimization is determined at block 746. If it is not the anchor frame, non-anchor frame image and depth time delta residue is determined at block 748, and a non-anchor frame time delta vision factor for pose graph optimization is determined at block 750.

A pose graph optimization block 752 determines an optimized graph using the pose graph, the IMU factor, the anchor frame vision factor, and the non-anchor frame vision factor. A status update is performed on the optimized pose graph at block 754, and marginalization is performed at block 756, resulting in a final sliding window at 758.

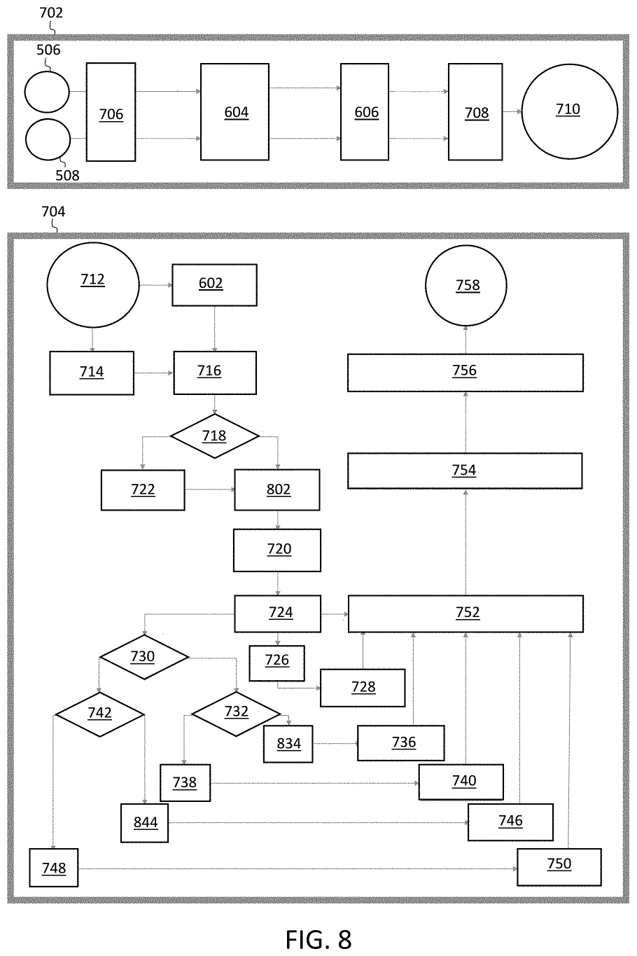

FIG. 8 is a diagram illustrating details on the implementation of the MSL-DVIO for 3D feature parameterization, according to an embodiment. The main difference between MSL-DVIO 3D feature and MSL-DVIO 1D feature is that the MS-DVIO 3D feature has a 2D feature location as part of the state, so the 2D location of the feature is estimated, at block 802, before the pose graph is created. A second difference is that the anchor frame vision factor has both image and depth residue. Specifically, anchor frame image and depth residue are determined at block 834, and anchor frame image and depth time delta residue is determined at block 844.

In this implementation of MSL-DVIO, the optimization for the vision factor is modified, but the IMU factor is unchanged for the overall optimization problem. When the VIO system is not subjected to aggressive motion, this does not have any impact. However, in some cases where the motion is relatively aggressive, especially during the initialization phase, a divergence in the trajectory may be observed.

The states may start diverging after the first graph optimization is run as part of the initialization step. Hence, a system design decision may be made to bring parity between the initialization step for MSL-DVIO and VINS-Mono. To achieve parity, the system may be modified as set forth below.

In MSL-DVIO 1D feature, computing depth residue is turned off for the anchor frame, and the depth residue is set to zero in the non-anchor frame for initialization step. The Jacobian in the vision factor specific to depth residue is also set toas zero.

The vision residue is set forth below in Equations (90), (91), and (92).

$${r}_{VIS}^{n o n} ( {x}_{i}^{R} , {x}_{j}^{R} , {λ}_{l} ) = [ \begin{matrix}{r}_{IMG} ( {x}_{i}^{R} , {x}_{j}^{R} , {λ}_{l} ) \\ {r}_{D P} ( {x}_{i}^{R} , {x}_{j}^{R} , {λ}_{l} )\end{matrix} ] \qquad ( 90 )$$

$${r}_{IMG} ( {x}_{i}^{R} , {x}_{j}^{R} , {λ}_{l} ) = g ( {T}_{c b} {T}_{{b}_{j} w} {T}_{{wb}_{i}} {T}_{bc} [ \frac{\overline{{u}_{ι l}}}{{λ}_{l}} , \frac{\overline{{v}_{ι l}}}{{λ}_{l}} , \frac{1}{{λ}_{l}} , 1 ] - {Z}_{lj}^{IMG} \qquad ( 91 )$$

$${r}_{D P} ( {x}_{i}^{R} , {x}_{j}^{R} , {λ}_{l} ) = 0 \qquad ( 92 )$$

The changed Jacobian part is set forth below in Equation (93).

$$\frac{\partial f ( {p}_{l}^{{c}_{j}} )}{\partial {p}_{l}^{{c}_{j}}} = [ \begin{matrix}\frac{1}{{z}_{l}^{{c}_{j}}} & 0 & \frac{{x}_{l}^{{c}_{j}}}{{z}_{l}^{{c}_{j}^{2}}} \\ 0 & \frac{1}{{z}_{l}^{{c}_{j}}} & \frac{{y}_{l}^{{c}_{j}}}{{z}_{l}^{{c}_{j}^{2}}} \\ 0 & 0 & 0\end{matrix} ] \qquad ( 93 )$$

In MSL-DVIO 3D feature, the initialization of the 2D feature in state may be turned off using the estimation algorithm described above. The 2D feature state is initialized with the 2D feature measurement in the anchor frame. The computing depth and image residue are turned off for the anchor frame and the depth residue is set to zero for the non-anchor frame. The Jacobian in the vision factor specific to 2D feature and depth residue is set to zero.

The vision residue is set forth below in Equations (94). (95). and (96)

$${r}_{VIS}^{n o n} ( {x}_{i}^{R} , {x}_{j}^{R} , {λ}_{l} ) = [ \begin{matrix}{r}_{IMG} ( {x}_{i}^{R} , {x}_{j}^{R} , {λ}_{l} ) \\ {r}_{D P} ( {x}_{i}^{R} , {x}_{j}^{R} , {λ}_{l} )\end{matrix} ] \qquad ( 94 )$$

$${r}_{IMG} ( {x}_{i}^{R} , {x}_{j}^{R} , {λ}_{l} ) = g ( {T}_{c b} {T}_{{b}_{j} w} {T}_{{wb}_{i}} {T}_{bc} [ \frac{\overline{{u}_{ι l}}}{{λ}_{l}} , \frac{\overline{{v}_{ι l}}}{{λ}_{l}} , \frac{1}{{λ}_{l}} , 1 ] - {Z}_{lj}^{IMG} \qquad ( 95 )$$

$${r}_{D P} ( {x}_{i}^{R} , {x}_{j}^{R} , {λ}_{l} ) = 0 \qquad ( 96 )$$

The changed Jacobian part is set forth below in Equation (97).

$$\frac{\partial f ( {p}_{l}^{{c}_{j}} )}{\partial {p}_{l}^{{c}_{j}}} = [ \begin{matrix}\frac{1}{{z}_{l}^{{c}_{j}}} & 0 & \frac{{x}_{l}^{{c}_{j}}}{{z}_{l}^{{c}_{j}^{2}}} \\ 0 & \frac{1}{{z}_{l}^{{c}_{j}}} & \frac{{y}_{l}^{{c}_{j}}}{{z}_{l}^{{c}_{j}^{2}}} \\ 0 & 0 & 0\end{matrix} ] \qquad ( 97 )$$

The stacked Jacobian for the feature parameter is set forth below in Equation (98).

$$\frac{\partial {r}_{VIS} ( {x}_{i}^{R} , {x}_{j}^{R} , {λ}_{l} )}{\partial {x}^{feat}} = [ \begin{matrix}0 & 0 & {A}_{1} \\ 0 & 0 & {A}_{2} \\ 0 & 0 & 0\end{matrix} ] , where \qquad ( 98 )$$

$$A = {[ {A}_{1} , {A}_{2} , {A}_{3} ]}^{T} = \frac{\partial {r}_{VIS} ( {x}_{i}^{R} , {x}_{j}^{R} , {λ}_{l} )}{\partial {λ}_{l}}$$

In depth initialization described above, depth initialization is turned off using the depth measurement.

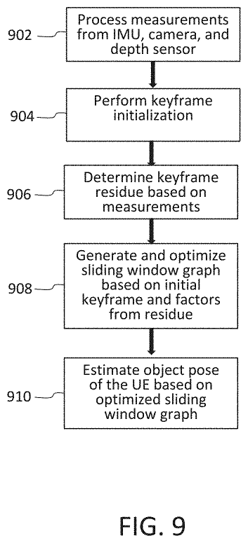

FIG. 9 is a flowchart illustrating a method for performing VIO at a UE, according to an embodiment. At 902, measurements are processed from an IMU, a camera, and a depth sensor of the UE. A data stream is received from the IMU and pre-integration is performed to generate an IMU pre-integrate term. A frame is captured through the camera, and feature detection and tracking are performed to generate a 2D feature track. A depth measurement is generated for a detected feature of the capture frame through the depth sensor.

Feature detection and tracking for the captured frame may be synchronized with the depth measurement. Feature velocity in image and depth domains may be computed based on the feature detection and tracking and the depth measurement.

At 904, keyframe initialization is performed using the IMU pre-integrate term and the 2D feature track to generate an initial keyframe.

At 906, keyframe residue is determined based on the processed measurements. The keyframe residue may include an IMU residue, a 2D feature residue, and a depth residue. The IMU residue is determined using the IMU pre-integrate term, the 2D feature residue is determined from the 2D feature track, and the depth residue is determined from the depth measurement. Specifically, the IMU residue is the loss between the estimated value of 6DOF pose for keyframes, velocity, and biases for the IMU, and the IMU measurement (e.g., accelerometer and gyroscope measurement). The image residue is the loss between the estimated value of the 6DOF pose for keyframes and the location of a landmark (1D or 3D), and the 2D measurement of the landmark on the keyframe. The depth residue is the loss between the estimated value of 6DOF pose for keyframes and the location of a landmark (1D or 3D), and the depth measurement of the landmark on the depth map.

At 908, a sliding window graph is generated and optimized based on the initial keyframe and factors derived from the keyframe residue. An IMU factor is determined based on the IMU residue. An anchor frame vision factor is determined based on the depth residue or based on the 2D feature residue and the depth residue, when the captured frame is an anchor frame. A non-anchor frame vision factor is determined based on the 2D feature residue and the depth residue, when the captured frame is a non-anchor frame. The anchor frame vision factor and the non-anchor frame vision factor may be based on a time offset equating time stamps of the camera, the depth sensor, and the IMU.

Generally, a vision factor is generated using vision sensors, which include the 6DOF pose of the keyframes, the location of the landmark, the depth residue, and the image residue. An IMU factor is generated using the IMU sensors, which include the 6DOF pose of the keyframes, velocity and biases of the IMU, and the IMU residue.

The sliding window graph is optimized based on the IMU factor and one of the anchor frame vision factor and the non-anchor frame vision factor. Optimization may include the two step marginalization described above.

During optimization, the state parameters are estimated such that there is a lowest residue for the graph at any given point in time.

At 910, an object pose of the UE is estimated based on the optimized sliding window graph.

To compare the performance of the MSL-DVIO system, test cases may be used that are composed of sequences, which have IMU camera and depth data, along with ground truth trajectory. Two types of sequences are provided.

Simulation sequences generate RGBD and IMU data for the trajectory.

Real world sequences are created by the VINS RGBD system, which has three (3) handheld sequences of roaming in a big room. These sequence may be created using a Realsense D435 sensor, and the ground truth may be generated using the MoCap system.

Depth uncertainty incorporated (DUI)-VIO sequences may be created using an occipital structure core sensor, and the ground truth may be generated using MoCap system.

The performance of the MSL-DVIO system is compared against the VINS-Mono and VINS RGBD.

The test metric used for the comparison is the root-mean-square-error (RMSE) of absolute translation error given by Equation (99) below.

$$RMSE = {( \frac{1}{n} {\sum }_{i}^{n} ‖ trans ( {Q}_{i}^{- 1} S {P}_{i} ) {‖}^{2} )}^{1 / 2} \qquad ( 99 )$$

where, Q is the ground truth trajectory, P is the estimated trajectory, and S is the rigid body transformation between the ground truth and estimated trajectory.

The comparative performance of the three systems for the sequences is provided in Table 7 below.

TABLE 7
ATE Performance Result

| Sequence | MSL-DVIO | MSL-DVIO | VINS- | VINS |
|---|---|---|---|---|
| Name | 1D Feature | 3D Feature | Mono | RGBD |
| u3d spiral | 0.032 | 0.046 | 0.145 | X |
| u3d sine | 0.036 | 0.037 | 0.353 | 0.084 |
| u3d simple | 0.241 | 0.213 | 0.575 | 0.369 |
| u3d normal | 0.122 | 0.189 | 0.795 | 0.453 |
| u3d rotation | 0.836 | 0.496 | 0.924 | 0.682 |
| rgbd simple | 0.184 | 0.205 | 0.228 | 0.183 |
| rgbd normal | 0.181 | 0.204 | 0.229 | 0.059 |
| rgbd rotation | 0.195 | 0.210 | 0.196 | 0.126 |
| corridor1 | X | X | 4.39 | 5.13 |
| corridor2 | 1.41 | 1.14 | 1.61 | 1.81 |
| corridor3 | 2.35 | 1.99 | 3.97 | 6.81 |
| corridor4 | 1.51 | 0.915 | 4.33 | 1.95 |
| hall1 | 0.694 | 2.36 | 4.8 | 2.34 |
| hall2 | 2.176 | 1.019 | 12.71 | 7.98 |
| hall3 | X | 6.61 | X | X |
| easy1 | 0.075 | 0.079 | 0.142 | 0.137 |
| easy2 | 0.067 | 0.073 | 0.175 | 0.431 |
| easy3 | 0.079 | 0.084 | 0.236 | 0.116 |
| dynamic1 | 0.157 | 0.159 | 0.287 | 0.216 |
| dynamic2 | 0.206 | 0.303 | 0.55 | 0.324 |
| dynamic3 | 0.294 | 0.293 | 0.653 | 0.52 |
| dynamic4 | 0.820 | 1.186 | 1.7 | 2.5 |
| dynamic5 | 0.060 | 0.118 | 0.469 | 0.177 |
| light1 | 0.871 | 0.361 | X | X |
| light2 | 0.37 | 0.3752 | 0.4 | 0.48 |
| light3 | 0.139 | 0.156 | 0.384 | X |
| light4 | 0.175 | 0.181 | 0.29 | 3.11 |
| light5 | 1.211 | 0.574 | X | 1.12 |
| light6 | 2.2 | 1.98 | 1.06 | X |
| motion1 | 0.292 | 0.371 | 0.526 | 0.581 |
| motion2 | 0.333 | 0.475 | 0.699 | 0.66 |
| motion3 | 0.158 | 0.161 | 0.452 | 0.361 |
| motion4 | 0.334 | 0.345 | 0.54 | 0.488 |
| motion5 | 0.250 | 0.226 | 0.373 | 0.378 |
| motion6 | 0.246 | 0.225 | 0.707 | 0.725 |

As shown in Table 7, the numbers in bold signify the best performance for the sequence, an “X” signifies that the system failed to initialize or resulted in a large ATE (>50 meters).

The timing performance of the different systems may also be compared to determine the real time performance of the algorithm and impact of the algorithm changes. For such a comparison, timing numbers of the MSL-DVIO 1D and MSL-DVIO 3D systems are evaluated with and without fast marginalization changes with VINS-Mono and VINS-RGBD system. The results are shown below in Table 8.

TABLE 8
Processing Time Evaluation of MSL-DVIO

| | | | | Triangu- |
|---|---|---|---|---|
| | Total | Ceres | | lation |
| | Time | Optimization | Marginalization | Time |
| | (mSec) | Time (mSec) | Time (mSec) | (mSec) |
| MSL-DVIO 1D | 54.0985 | 0.0558 | 45.5234 | 4.9316 |
| (With Fast | | | | |
| Marginalization) | | | | |
| MSL-DVIO 3D | 83.527 | 1.0526 | 54.2526 | 25.4595 |
| (With Fast | | | | |
| Marginalization) | | | | |
| MSL-DVIO 1D | 69.6035 | 0.0462 | 37.3896 | 27.5371 |
| (Without Fast | | | | |
| Marginalization) | | | | |
| MSL-DVIO 1D | 449.92 | 0.718 | 39.0122 | 407.3284 |
| (Without Fast | | | | |
| Marginalization) | | | | |
| VINS-Mono | 61.4034 | 0.0505 | 30.7614 | 26.7074 |
| VINS-RGBD | 61.4034 | 0.0505 | 30.7614 | 26.7074 |

As shown in Table 8, with fast marginalization changes, the marginalization processing time for both MSL-DVIO 1D (˜80% improvement) and MSL-DVIO 3D (˜94% improvement) is improved. Accordingly, a real time performance of ˜18 Hz for MSL-DVIO 1D and ˜11 Hz for MSL-DVIO 3D is achieved. Both numbers are higher than 10 Hz requirement for the nonlinear optimization thread to enable real time performance of the complete VIO system.

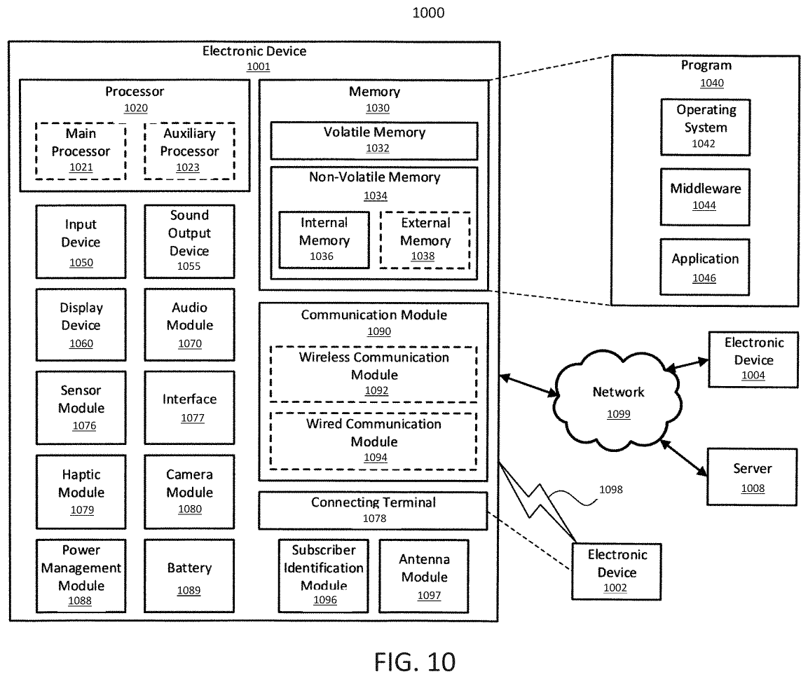

FIG. 10 is a block diagram of an electronic device in a network environment, according to one embodiment. Referring to FIG. 10, an electronic device 1001 in a network environment 1000 may communicate with an electronic device 1002 via a first network 1098 (e.g., a short-range wireless communication network), or an electronic device 1004 or a server 1008 via a second network 1099 (e.g., a long-range wireless communication network). The electronic device 1001 may communicate with the electronic device 1004 via the server 1008. The electronic device 1001 may include a processor 1020, a memory 1030, an input device 1050, a sound output device 1055, a display device 1060, an audio module 1070, a sensor module 1076, an interface 1077, a haptic module 1079, a camera module 1080, a power management module 1088, a battery 1089, a communication module 1090, a subscriber identification module (SIM) 1096, or an antenna module 1097. In one embodiment, at least one (e.g., the display device 1060 or the camera module 1080) of the components may be omitted from the electronic device 1001, or one or more other components may be added to the electronic device 1001. Some of the components may be implemented as a single integrated circuit (IC). For example, the sensor module 1076 (e.g., a fingerprint sensor, an iris sensor, or an illuminance sensor) may be embedded in the display device 1060 (e.g., a display).

The processor 1020 may execute, for example, software (e.g., a program 1040) to control at least one other component (e.g., a hardware or a software component) of the electronic device 1001 coupled with the processor 1020, and may perform various data processing or computations. As at least part of the data processing or computations, the processor 1020 may load a command or data received from another component (e.g., the sensor module 1076 or the communication module 1090) in volatile memory 1032, process the command or the data stored in the volatile memory 1032, and store resulting data in non-volatile memory 1034. The processor 1020 may include a main processor 1021 (e.g., a central processing unit (CPU) or an application processor (AP)), and an auxiliary processor 1023 (e.g., a graphics processing unit (GPU), an image signal processor (ISP), a sensor hub processor, or a communication processor (CP)) that is operable independently from, or in conjunction with, the main processor 1021. Additionally or alternatively, the auxiliary processor 1023 may be adapted to consume less power than the main processor 1021, or execute a particular function. The auxiliary processor 1023 may be implemented as being separate from, or a part of, the main processor 1021.

The auxiliary processor 1023 may control at least some of the functions or states related to at least one component (e.g., the display device 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). The auxiliary processor 1023 (e.g., an image signal processor or a communication processor) may be implemented as part of another component (e.g., the camera module 1080 or the communication module 1090) functionally related to the auxiliary processor 1023.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input device 1050 may receive a command or data to be used by other component (e.g., the processor 1020) of the electronic device 1001, from the outside (e.g., a user) of the electronic device 1001. The input device 1050 may include, for example, a microphone, a mouse, or a keyboard.

The sound output device 1055 may output sound signals to the outside of the electronic device 1001. The sound output device 1055 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1060 may visually provide information to the outside (e.g., a user) of the electronic device 1001. The display device 1060 may include, for example, a display, a hologram device, or a projector and control circuitry to control a corresponding one of the display, hologram device, and projector. The display device 1060 may include touch circuitry adapted to detect a touch, or sensor circuitry (e.g., a pressure sensor) adapted to measure the intensity of force incurred by the touch.

The audio module 1070 may convert a sound into an electrical signal and vice versa. The audio module 1070 may obtain the sound via the input device 1050, or output the sound via the sound output device 1055 or a headphone of an external electronic device 1002 directly (e.g., wired) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. The sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device 1002 directly (e.g., wired) or wirelessly. The interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device 1002. The connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or an electrical stimulus which may be recognized by a user via tactile sensation or kinesthetic sensation. The haptic module 1079 may include, for example, a motor, a piezoelectric element, or an electrical stimulator.

The camera module 1080 may capture a still image or moving images. The camera module 1080 may include one or more lenses, image sensors, image signal processors, or flashes.

The power management module 1088 may manage power supplied to the electronic device 1001. The power management module 1088 may be implemented as at least part of, for example, a power management integrated circuit (PMIC).

The battery 1089 may supply power to at least one component of the electronic device 1001. The battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the AP) and supports a direct (e.g., wired) communication or a wireless communication. The communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or a standard of the Infrared Data Association (IrDA)) or the second network 1099 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The antenna module 1097 may transmit or receive a signal or power to or from the outside (e.g., the external electronic device) of the electronic device 1001. The antenna module 1097 may include one or more antennas, and, therefrom, at least one antenna appropriate for a communication scheme used in the communication network, such as the first network 1098 or the second network 1099, may be selected, for example, by the communication module 1090 (e.g., the wireless communication module 1092). The signal or the power may then be transmitted or received between the communication module 1090 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

Commands or data may be transmitted or received between the electronic device 1001 and the external electronic device 1004 via the server 1008 coupled with the second network 1099. Each of the electronic devices 1002 and 1004 may be a device of a same type as, or a different type, from the electronic device 1001. All or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, or client-server computing technology may be used, for example.

One embodiment may be implemented as software (e.g., the program 1040) including one or more instructions that are stored in a storage medium (e.g., internal memory 1036 or external memory 1038) that is readable by a machine (e.g., the electronic device 1001). For example, a processor of the electronic device 1001 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method for performing visual inertial odometry (VIO) at a user equipment (UE), the method comprising:
processing measurements from an inertial measurement unit (IMU), a camera, and a depth sensor of the UE;
determining keyframe residue comprising at least depth residue based on the processed measurements;
generating and optimizing a sliding window graph based on factors derived from the keyframe residue; and
estimating an object pose of the UE based on the optimized sliding window graph.

2. The method of claim 1, wherein processing the measurements comprises:
receiving a data stream from the IMU and performing pre-integration for the data stream to generate an IMU pre-integrate term;
capturing a frame through the camera, and performing feature detection and tracking for the captured frame to generate a two-dimensional (2D) feature track; and
generating a depth measurement for a detected feature of the captured frame through the depth sensor.

3. The method of claim 2, wherein determining the keyframe residue comprises:
determining an IMU residue using the IMU pre-integrate term;
determining a 2D feature residue from the 2D feature track; and
determining the depth residue from the depth measurement.

4. The method of claim 3, wherein generating and optimizing the sliding window graph comprises:
determining an IMU factor based on the IMU residue;
determining an anchor frame vision factor based on at least the depth residue, in case that the captured frame is an anchor frame;
determining a non-anchor frame vision factor based on the 2D feature residue and the depth residue, in case that the captured frame is a non-anchor frame; and
optimizing the sliding window graph based on the IMU factor and one of the anchor frame vision factor and the non-anchor frame vision factor.

5. The method of claim 4, wherein the anchor frame vision factor is determined based on the 2D feature residue and the depth residue.

6. The method of claim 4, wherein the anchor frame vision factor and the non-anchor frame vision factor are based on a time offset equating time stamps of the camera, depth sensor, and the IMU.

7. The method of claim 2, further comprising performing keyframe initialization using the IMU pre-integrate term and the 2D feature track to generate an initial keyframe, wherein the sliding window graph is generated based on the initial keyframe.

8. The method of claim 2, further comprising synchronizing feature detection and tracking for the captured frame with depth measurement of the detected feature.

9. The method of claim 2, further comprising computing feature velocity in image and depth domains based on the feature detection and tracking and the depth measurement.

10. The method of claim 4, wherein optimizing the sliding window graph comprises:
performing marginalization of landmarks in the captured frame; and
performing marginalization of keyframe pose, speed, and bias terms.

11. A user equipment (UE) comprising:
an inertial measurement unit (IMU);
a camera;
a depth sensor;
a processor; and
a non-transitory computer readable storage medium storing instructions that, when executed, cause the processor to:
process measurements from the IMU, the camera, and the depth sensor;
determine keyframe residue comprising at least depth residue based on the processed measurements;
generate and optimize a sliding window graph based on factors derived from the keyframe residue; and
estimate an object pose of the UE based on the optimized sliding window graph.

12. The UE of claim 11, wherein, in processing the measurements, the instructions further cause the processor to:
receive a data stream from the IMU and performing pre-integration for the data stream to generate an IMU pre-integrate term;
capture a frame through the camera, and performing feature detection and tracking for the captured frame to generate a two-dimensional (2D) feature track; and
generate a depth measurement for a detected feature of the captured frame through the depth sensor.

13. The UE of claim 12, wherein, in determining the keyframe residue, the instructions further cause the processor to:
determine an IMU residue using the IMU pre-integrate term;
determine a 2D feature residue from the 2D feature track; and
determine the depth residue from the depth measurement.

14. The UE of claim 13, wherein, in generating and optimizing the sliding window graph, the instructions further cause the processor to:
determine an IMU factor based on the IMU residue;
determine an anchor frame vision factor based on at least the depth residue, in case that the captured frame is an anchor frame;
determine a non-anchor frame vision factor based on the 2D feature residue and the depth residue, in case that the captured frame is a non-anchor frame; and
optimize the sliding window graph based on the IMU factor and one of the anchor frame vision factor and the non-anchor frame vision factor.

15. The UE of claim 14, wherein the anchor frame vision factor is determined based on the 2D feature residue and the depth residue.

16. The UE of claim 14, wherein the anchor frame vision factor and the non-anchor frame vision factor are based on a time offset equating time stamps of the camera, depth sensor, and the IMU.

17. The UE of claim 12, wherein the instructions further cause the processor to perform keyframe initialization using the IMU pre-integrate term and the 2D feature track to generate an initial keyframe, wherein the sliding window graph is generated based on the initial keyframe.

18. The UE of claim 12, wherein the instructions further cause the processor to synchronize feature detection and tracking for the captured frame with depth measurement of the detected feature.

19. The UE of claim 12, wherein the instructions further cause the processor to compute feature velocity in image and depth domains based on the feature detection and tracking and the depth measurement.

20. The UE of claim 14, wherein, in optimizing the sliding window graph, the instructions further cause the processor to:
perform marginalization of landmarks in the captured frame; and
perform marginalization of keyframe pose, speed, and bias terms.
